(19) United States
(12) Patent Application Publication
(10) Pub. No.: US 2026/0012641 A1
(43) Pub. Date: Jan. 8, 2026

(54) NON-SEPARABLE TRANSFORM KERNEL SELECTION BASED ON PREDICTION TYPE IN VIDEO CODING

(71) Applicant: QUALCOMM Incorporated, San Diego, CA (US)

(72) Inventors: Marta Karczewicz, San Diego, CA (US); Gleb Verba, Munich (DE); Bappaditya Ray, San Diego, CA (US); Patrick Garus, München (DE); Muhammed Zeyd Coban, Carlsbad, CA (US); Vadim Seregin, San Diego, CA (US)

(21) Appl. No.: 19/261,123

(22) Filed: Jul. 7, 2025

Related U.S. Application Data
(60) Provisional application No. 63/668,699, filed on Jul. 8, 2024.
(60) Provisional application No. 63/705,883, filed on Oct. 10, 2024.

(51) Int. Cl. H04N 19/61; H04N 19/122; H04N 19/159; H04N 19/176

(52) U.S. Cl. CPC H04N 19/61; H04N 19/122; H04N 19/159; H04N 19/176

(57) ABSTRACT

A device for decoding video data, the device comprising: a memory configured to store the video data; and one or more processors implemented in circuitry, the one or more processors configured to: determine, based on a prediction type associated with a transform block, a non-separable transform kernel set, wherein the non-separable transform kernel set is a non-separable primary transform (NSPT) kernel set or a low-frequency non-separable transform (LFNST) kernel set; select a kernel from the non-separable transform kernel set; apply one or more transforms to the transform block to reconstruct a residual block, wherein applying the one or more transforms comprises applying a non-separable transform to the transform block using the kernel; and reconstruct a block of the video data based on the residual block and a prediction block.

This application claims the benefit of U.S. Provisional Patent Application 63/668,699, filed Jul. 8, 2024, and U.S. Provisional Patent Application 63/705,883, filed Oct. 10, 2024, the entire content of each of which is incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques related to non-separable transforms used in video compression. The disclosed methods can be applied to any of the existing video codecs, such as HEVC (High Efficiency Video Coding), VVC (Versatile Video Coding), Essential Video Coding (EVC) or be an efficient coding tool in future video coding standards (e.g., ECM (Enhanced Compression Model)). A non-separable primary transform (NSPT) kernel may be selected implicitly based on an applied or derived intra mode and the transform block size. Low-frequency non-separable transform (LFNST) is mostly used with 16×16 kernels after the introduction of NSPT, and a kernel set is chosen implicitly based on the applied or derived intra mode and does not depend on the transform block size. A kernel in a set is chosen explicitly. This design does not provide sufficient adaptation to the content, since the input statistic may vary significantly for each kernel.

This disclosure describes techniques for determining kernel sets for non-separable transforms. In accordance with a technique of this disclosure, a kernel set for NSPT/LFNST may be selected based on a prediction type. Example prediction types include directional intra prediction, template-based intra mode derivation (TIMD), decoder-side intra mode derivation (DIMD), spatial geometric partitioning mode (SGPM), extrapolation filter-based intra prediction (EIP), matrix-based intra prediction (MIP), intra template matching prediction (ITMP), intra block copy (IBC), non-affine inter prediction, and affine inter prediction. Selecting kernels for non-separable transforms may improve video compression performance.

In one example, a device for decoding video data, the device comprising: a memory configured to store the video data; and one or more processors implemented in circuitry, the one or more processors configured to: apply one or more transforms to a transform block to reconstruct a residual block, wherein the one or more processors are configured to, as at least part of applying the one or more transforms: determine, based on a prediction type associated with the transform block, a non-separable transform kernel set, wherein the non-separable transform kernel set is a non-separable primary transform (NSPT) kernel set or a low-frequency non-separable transform (LFNST) kernel set; select a kernel from the non-separable transform kernel set; and apply a non-separable transform to the transform block using the kernel; and reconstruct a block of the video data based on the residual block and a prediction block.

In another example, this disclosure describes a method of decoding video data, the method comprising: determining, based on a prediction type associated with a transform block, a non-separable transform kernel set, wherein the non-separable transform kernel set is a non-separable primary transform (NSPT) kernel set or a low-frequency non-separable transform (LFNST) kernel set; selecting a kernel from the non-separable transform kernel set; applying one or more transforms to the transform block to reconstruct a residual block, wherein applying the one or more transforms comprises applying a non-separable transform to the transform block using the kernel; and reconstructing a block of the video data based on the residual block and a prediction block.

In another example, this disclosure describes one or more non-transitory computer-readable storage media having instructions stored thereon that, when executed by one or more processors, cause the one or more processors to: determine, based on a prediction type associated with a transform block, a non-separable transform kernel set, wherein the non-separable transform kernel set is a non-separable primary transform (NSPT) kernel set or a low-frequency non-separable transform (LFNST) kernel set; select a kernel from the non-separable transform kernel set; apply one or more transforms to the transform block to reconstruct a residual block, wherein applying the one or more transforms comprises applying a non-separable transform to the transform block using the kernel; and reconstruct a block of video data based on the residual block and a prediction block.

In one example, this disclosure describes a method of coding video data, the method comprising: determining, based on a prediction type associated with a transform block, a kernel for a non-separable transform; and applying a non-separable transform to the transform block using the determined kernel.

In another example, this disclosure describes a method of coding video data, the method comprising: determining, based on transform block dimensions, a kernel for a non-separable transform; and applying a non-separable transform to a transform block using the determined kernel.

In another example, this disclosure describes a method of coding video data, the method comprising: determining a region of interest for a low-frequency non-separable transform (LFNST) region based on one or more of a prediction type of a transform block or dimensions of the transform block; and applying a non-separable transform to the region of interest of the transform block.

In another example, a device includes means for performing any of the methods of this disclosure.

In another example, a computer-readable storage medium is encoded with instructions that, when executed, cause a programmable processor to perform any of the methods of this disclosure.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block in accordance with the techniques of this disclosure.

FIG. 5 is a flowchart illustrating an example method for decoding a current block in accordance with the techniques of this disclosure.

FIG. 6 is a conceptual diagram illustrating a region of interest for LFNST16.

FIG. 7 is a conceptual diagram illustrating a region of interest for LFNST8.

FIG. 8 is a conceptual diagram illustrating example Mapping from Intra Prediction (MIP) prediction samples to build a histogram of gradient.

FIG. 9 is a table illustrating a mapping of intra prediction modes to a low-frequency non-separable transform (LFNST) set index.

FIG. 10 is a conceptual diagram illustrating an overview of non-separable primary transforms (NSPTs) among existing LFNSTs.

FIG. 11 is a conceptual diagram illustrating regular intra prediction modes in VVC Test Model (VTM) 7.0.

FIG. 12 is a conceptual diagram illustrating an example matrix intra prediction process.

FIG. 13 is a conceptual diagram illustrating an example histogram of gradient computation.

FIG. 14 is a conceptual diagram illustrating an example of weight determination and final predictor generation.

FIG. 15 is a conceptual diagram illustrating an example template and reference samples used in template-based intra model derivation with fusion (TIMD).

FIG. 16 is a conceptual diagram illustrating an example of spatial geometric partitioning mode.

FIG. 17 is a flowchart illustrating an example operation of a video encoder, in accordance with one or more techniques of this disclosure.

FIG. 18 is a flowchart illustrating an example operation of a video decoder, in accordance with one or more techniques of this disclosure.

### DETAILED DESCRIPTION

Current video coding designs do not provide sufficient adaptation to content being coded, since input statistics may vary significantly for each transform kernel that may be applied. As a result, coding efficiency may not be as great as possible. This disclosure describes techniques for selecting a kernel set for non-separable transforms. In accordance with a technique of this disclosure, a video encoder or a video decoder may determine a non-separable transform kernel set. The non-separable transform kernel set may be a non-separable primary transform (NSPT) kernel set or a low-frequency non-separable transform (LFNST) kernel set. The video encoder or the video decoder may select the kernel set for NSPT/LFNST based on one or more of a prediction type or transform block dimensions of a transform block. Example prediction types include directional intra prediction, template-based intra mode derivation (TIMD), decoder-side intra mode derivation (DIMD), spatial geometric partitioning mode (SGPM), extrapolation filter-based intra prediction (EIP), matrix-based intra prediction (MIP), intra template matching prediction (ITMP), intra block copy (IBC), non-affine inter prediction, and affine inter prediction. The video encoder or video decoder may then select a kernel in the determined kernel set. The video encoder or the video decoder may then apply a non-separable transform to the transform block using the kernel. Additionally, this disclosure describes techniques for determining a region of interest (ROI) dependent on a prediction type or transform block dimensions. Selecting kernels for non-separable transforms and selecting ROIs in accordance with techniques of this disclosure may improve video compression performance.

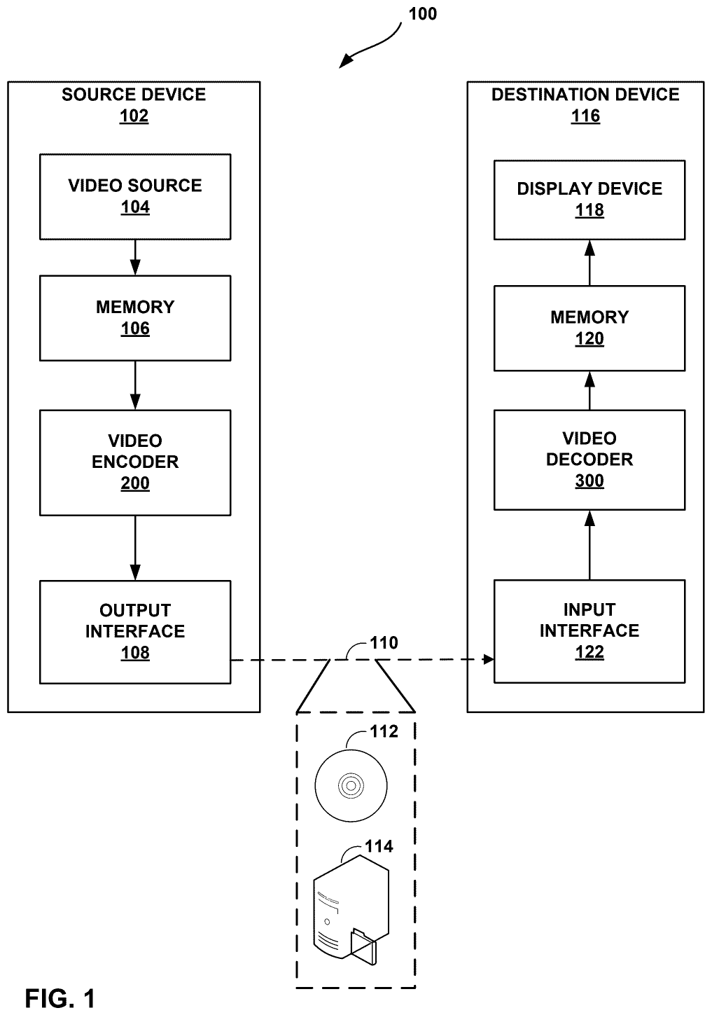

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for selection of a non-separable transform kernel. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for selection of a non-separable transform kernel. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use LFNST and NSPT.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra-or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

Any of the video encoding or video decoding processes described above may be performed using a neural network (NN). Additionally or alternatively, a neural network may be trained to efficiently compress video data without necessarily separately performing prediction and residual coding. Studies have shown that embedding neural networks into the hybrid video coding framework of video encoder 200 and video decoder 300 can improve compression efficiency. Neural networks may be used for intra prediction and inter prediction to improve the prediction efficiency. NN-based in-loop filtering and/or post-filtering have also performed well in heuristic testing.

For example, video encoder 200 and video decoder may use one or more NN-based filters for existing filters, such as deblocking filters, sample adaptive offset (SAO), and/or adaptive loop filtering (ALF). NN-based filters can also be applied exclusively, where NN-based filters are designed to replace all of the existing filters. Additionally or alternatively, NN-based filters may be designed to supplement, enhance, or replace any or all of the other filters.

In the current ECM design, video encoder 200 and video decoder 300 select a NSPT kernel set implicitly based on the applied or derived intra mode and the transform block size. LFNST is mostly used with 16×16 kernels after the introduction of NSPT, and an LFNST kernel set is chosen implicitly based on the applied or derived intra mode and does not depend on the transform block size. For both NSPT and LFNST, a kernel within the kernel set is chosen explicitly. This design does not provide sufficient adaptation to the content, since the input statistic may vary significantly for each kernel. Residual characteristics vary based on the prediction type even if the intra direction is the same. For example, a block of dimensions W×H with a regular intra prediction mode (VVC like) with mode 18, i.e., horizontal direction), and a W×H block fusion mode with a dominant horizontal direction (mode 18) uses the same NSPT/LFNST although the residual characteristics may be different (one is regular, and another is fusion). The techniques of this disclosure define separate kernels based on the prediction type (for example, regular intra vs DIMD) to better account for the varying characteristics.

The techniques of this disclosure may address this problem. In accordance with one or more techniques of this disclosure, video encoder 200 (e.g., residual generation unit 204) may generate residual data based on a block of video data (e.g., a CU) and a prediction block (e.g., one or more PUs). Additionally, video encoder 200 (e.g., transform processing unit 206) may apply one or more transforms to the residual data to generate transformed data of a transform block. As at least part of applying the one or more transforms, video encoder 200 may determine, based on a prediction type associated with the transform block, a non-separable transform kernel set. The non-separable transform kernel set may be a NSPT kernel set or an LFNST kernel set. Additionally, video encoder 200 may select a kernel from the kernel set (1704). Video encoder 200 may then apply a non-separable transform to the transform block using the kernel. Determining the kernel set based on the prediction type associated with the transform block may enable video encoder 200 to generate a more compact bitstream that encodes the data with fewer bits, keeping the same quality (or loss, or distortion) level. The bitstream may be more compact because when the transform is adaptively determined based on the prediction type associated with the transform block, fewer significant (i.e., non-zero) transform coefficients and/or smaller-valued transform coefficients may be needed to represent the transform block.

Furthermore, in accordance with one or more techniques of this disclosure, video decoder 300 may apply one or more transforms to a transform block to reconstruct a residual block. As at least part of applying the one or more transforms, video decoder 300 may determine, based on a prediction type associated with the transform block, a non-separable transform kernel set. The non-separable transform kernel set may be an NSPT kernel set or a LFNST kernel set. Additionally, video decoder 300 may select a kernel from the kernel set. Video decoder 300 may apply a non-separable transform to the transform block using the kernel. Video decoder 300 may reconstruct a block of the video data based on the residual block and a prediction block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

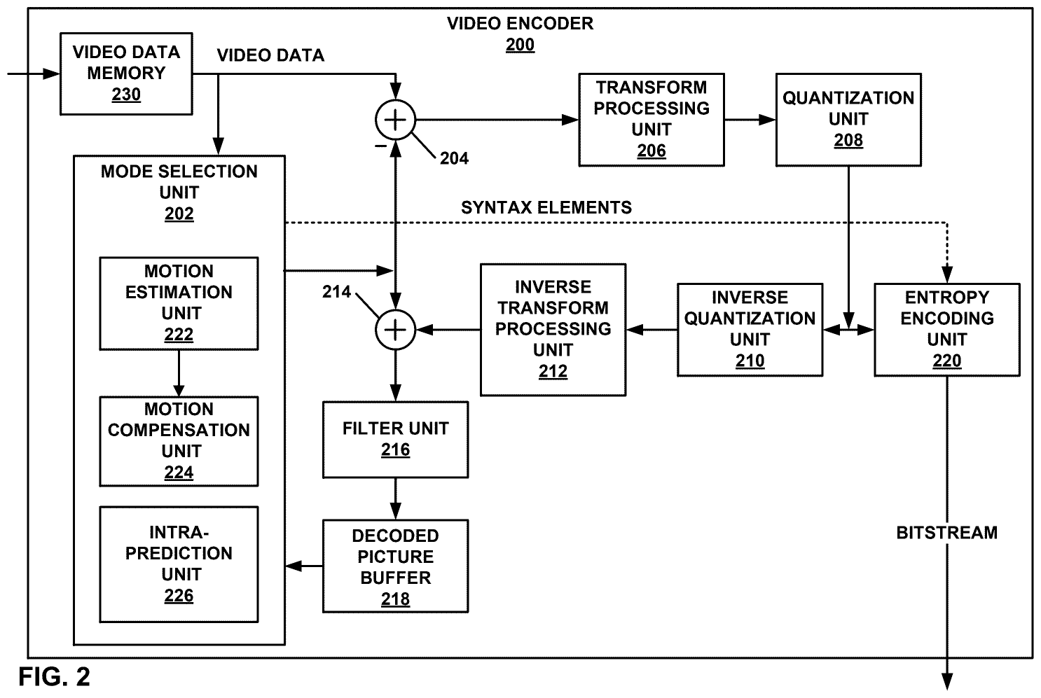

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUS, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AVI video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

In accordance with one or more techniques of this disclosure, transform processing unit 206 may determine, based on a prediction type associated with a transform block, a non-separable transform kernel set. The non-separable transform kernel set is a non-separable primary transform (NSPT) kernel set or a low-frequency non-separable transform (LFNST) kernel set. Additionally, transform processing unit 206 may select a kernel from the non-separable transform kernel set. Transform processing unit 206 may then apply a non-separable transform to the transform block using the kernel.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 may represents an example of a device configured to encode video data including a memory configured to store video data, and one or more processing units implemented in circuitry and configured to determine, based on a prediction type associated with a transform block, a kernel for a non-separable transform; and apply a non-separable transform to a transform block using the determined kernel. In some examples, video encoder 200 represents an example of a device configured to encode video data including a memory configured to store video data, and one or more processing units implemented in circuitry and configured to determine, based on transform block dimensions, a kernel for a non-separable transform; and apply a non-separable transform to a transform block using the determined kernel. In some examples, video encoder 200 represents an example of a device configured to encode video data including a memory configured to store video data, and one or more processing units implemented in circuitry and configured to determine a region of interest for a low-frequency non-separable transform (LFNST) region based on one or more of a prediction type associated with a transform block or dimensions of the transform block; and apply a non-separable transform to the region of interest of the transform block.

In some examples, video encoder 200 may represent an example of a device configured to encode video data including a memory configured to store video data, and one or more processing units implemented in circuitry and configured to generate residual data based on a block of video data (e.g., a CU) and a prediction block (e.g., one or more PUs); apply one or more transforms to the residual data to generate transformed data of a transform block. As at least part of applying the one or more transforms, video encoder 200 may determine, based on a prediction type associated with a transform block, a non-separable transform kernel set; select a kernel from the non-separable transform kernel set; apply a non-separable transform to the transform block using the kernel.

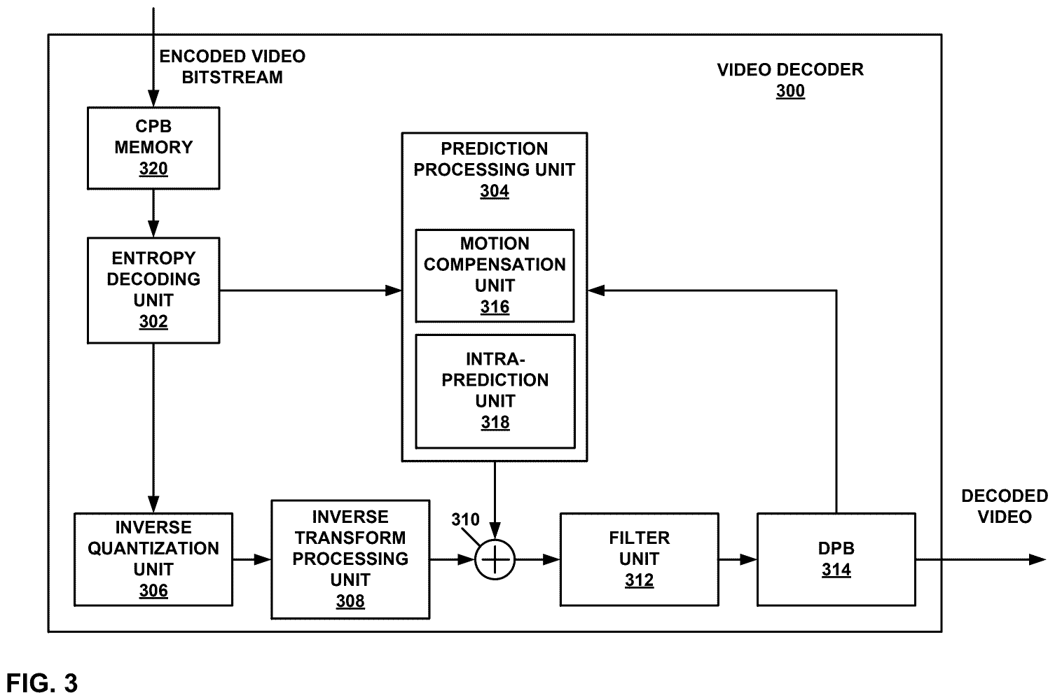

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

In accordance with one or more techniques of this disclosure, inverse quantization unit 306 may apply one or more transforms to a transform block to reconstruct a residual block. As at least part of applying the one or more transforms, inverse quantization unit 306 may determine, based on a prediction type associated with the transform block, a non-separable transform kernel set. The non-separable transform kernel set may be a non NSPT kernel set or a low-frequency non-separable transform (LFNST) kernel set. Inverse quantization unit 306 may select a kernel from the non-separable transform kernel set. Inverse quantization unit 306 may apply a non-separable transform to the transform block using the kernel.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 may represent an example of a video decoding device including a memory configured to store video data, and one or more processing units implemented in circuitry and configured to determine, based on a prediction type associated with a transform block, a kernel for a non-separable transform; and apply a non-separable transform to a transform block using the determined kernel. In some examples, video decoder 300 represents an example of a video decoding device including a memory configured to store video data, and one or more processing units implemented in circuitry and configured to determine, based on transform block dimensions, a kernel for a non-separable transform; and apply a non-separable transform to a transform block using the determined kernel. In some examples, video decoder 300 represents an example of a video decoding device including a memory configured to store video data, and one or more processing units implemented in circuitry and configured to determine a region of interest for a low-frequency non-separable transform (LFNST) region based on one or more of a prediction type associated with a transform block or dimensions of the transform block; and apply a non-separable transform to the region of interest of the transform block.

In some examples, video decoder 300 may represent an example of a video decoding device including a memory configured to store video data, and one or more processing units implemented in circuitry and configured to apply one or more transforms to a transform block to reconstruct a residual block. As at least part of applying the one or more transforms, video decoder 300 may determine, based on a prediction type associated with the transform block, a non-separable transform kernel set. The non-separable transform kernel set may be a non NSPT kernel set or a low-frequency non-separable transform (LFNST) kernel set. Video decoder 300 may select a kernel from the non-separable transform kernel set. Video decoder 300 may apply a non-separable transform to the transform block using the kernel. Video decoder 300 may reconstruct a block of the video data based on the residual block and a prediction block.

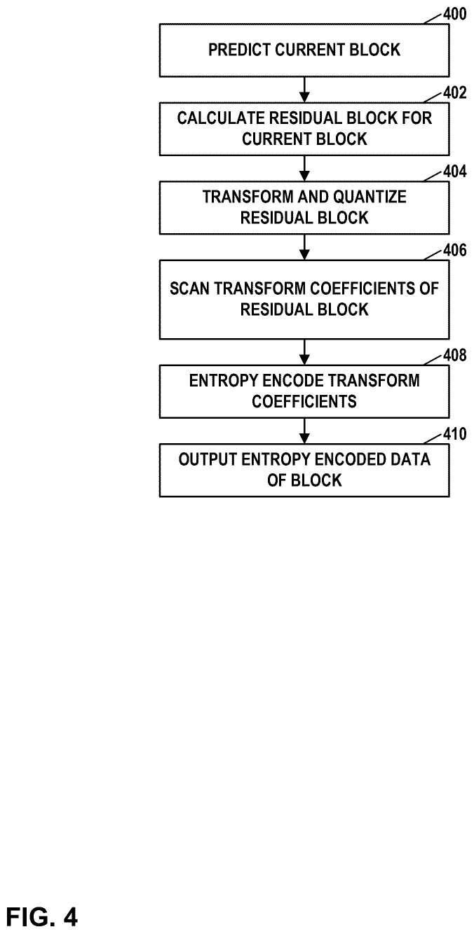

FIG. 4 is a flowchart illustrating an example method for encoding a current block in accordance with the techniques of this disclosure. The current block may be or include a current CU. Although described with respect to video encoder 200 (FIGS. 1 and 2), it should be understood that other devices may be configured to perform a method similar to that of FIG. 4.

In this example, video encoder 200 initially predicts the current block (400). For example, video encoder 200 may form a prediction block for the current block. Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

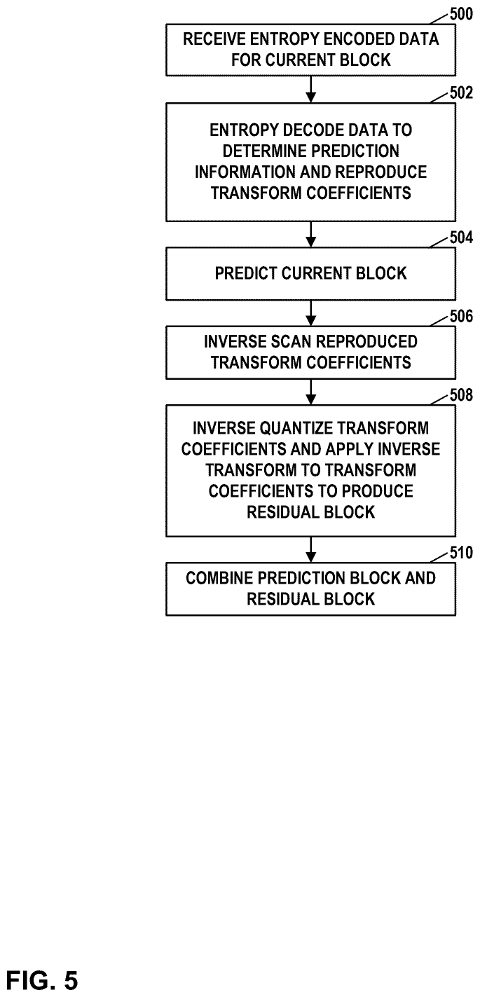

FIG. 5 is a flowchart illustrating an example method for decoding a current block of video data in accordance with the techniques of this disclosure. The current block may be or include a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may then inverse scan the reproduced transform coefficients (506), to create a block of quantized transform coefficients. Video decoder 300 may then inverse quantize the transform coefficients and apply an inverse transform to the transform coefficients to produce a residual block (508). Video decoder 300 may ultimately decode the current block by combining the prediction block and the residual block (510).

As mentioned above, video encoder 200 may apply one or more transforms to residual data to generate transform data. Similarly, video decoder 300 may apply one or more transforms to convert transform data to reconstruct residual data. In some examples, video encoder 200 first applies a primary transform, such as a discrete cosine transform (DCT) to the residual data to generate a primary transform block (i.e., a block of primary transform coefficients). Video encoder 200 may then apply a secondary transform, such as a low-frequency non-separable transform (LFNST) to the primary transform block to generate a secondary transform block comprising secondary transform coefficients. Video decoder 300 may apply an inverse LFNST to the secondary transform block to at least partially reconstruct the primary transform block, and then apply an inverse primary transform to the primary transform block to reconstruct the residual data.

To apply the LFNST, video encoder 200 may map an N dimensional vector to an R dimensional vector through an R×N matrix. The R×N matrix may be referred to as a kernel. N corresponds to a number of primary transform coefficients in a region of interest (ROI) in the primary transform block. Thus, video encoder 200 may multiply an N-dimensional vector comprising primary transform coefficients in the ROI by the R×N kernel. Video encoder 200 may zero out primary transform coefficients of the primary transform block outside the ROI. Video encoder 200 may store multiple sets of LFNST kernels. Each LFNST kernel set may include one or more candidate LFNST kernels. Different LFNST kernel sets may correspond to different transform block dimensions. After determining an LFNST kernel set for a transform block, video encoder 200 may select one of the kernels in the LFNST kernel set and apply a forward LFNST to the transform block using the selected kernel.

Video decoder 300 may store sets of LFNST kernels. The LFNST kernels stored by video decoder 300 may be N×R instead of R×N. Thus, multiplying transform coefficients by a kernel effectively upsamples the transform coefficients instead of downsampling the transform coefficients. When applying transforms to a transform block to reconstruct a residual block, video decoder 300 may determine the LFNST kernel set for the transform block, select a kernel from the LFNST kernel set, and apply an LFNST transform on the transform block using the kernel to reconstruct primary transform coefficients in the ROI of the primary transform block. Video encoder 200 and video decoder 300 may select the LFNST kernel set based on an intra prediction mode associated with the transform block.

The LFNST design in VVC is extended as follows:
The number of LFNST sets (S) and candidates (C) are extended to S=35 and C=3, and the LFNST set (lfnstTrSetIdx) for a given intra mode (predModeIntra) is derived according to the following formula:

For predModeIntra<2, lfnstTrSetIdx is equal to 2

lfnstTrSetIdx=predModeIntra, for predModeIntra in [0,34]

lfnstTrSetIdx=68−predModeIntra, for predModeIntra in [35,66]
Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively.

The kernel dimensions are specified by:

$$( LFSNT 4 , LFNST {8}^{*} , LFNST {16}^{*} ) = ( 16 \times 16 , 32 \times 64 , 32 \times 96 )$$

The forward LFNST is applied to a top-left low frequency region, which is called a Region-Of-Interest (ROI). When LFNST is applied, primary-transformed coefficients that exist in the region other than ROI are zeroed out, which is not changed from the VVC standard.

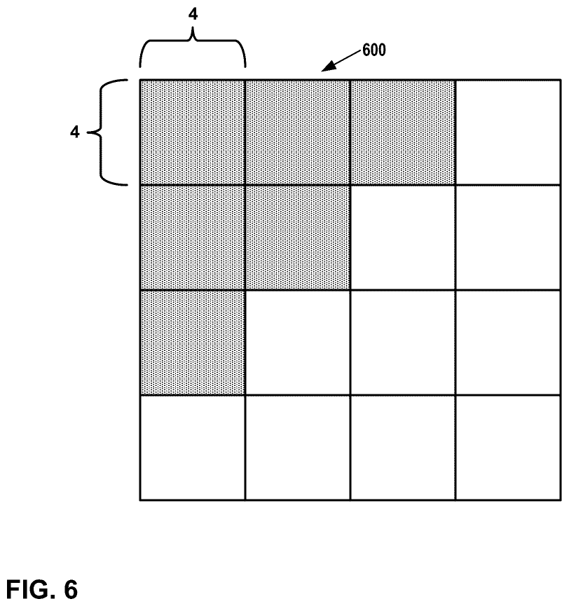

FIG. 6 is a conceptual diagram illustrating a region of interest (ROI) 600 for LFNST16. ROI 600 consists of six 4×4 sub-blocks, which are consecutive in scan order. Since the number of input samples is 96, a transform matrix for forward LFNST16 can be R×96. R is chosen to be 32 in this contribution, 32 coefficients (two 4×4 sub-blocks) are generated from forward LFNST16 accordingly, which are placed following coefficient scan order. That is, the 96 coefficients of the six 4×4 sub-blocks are multiplied by the 32×96 matrix to output the 32 coefficients.

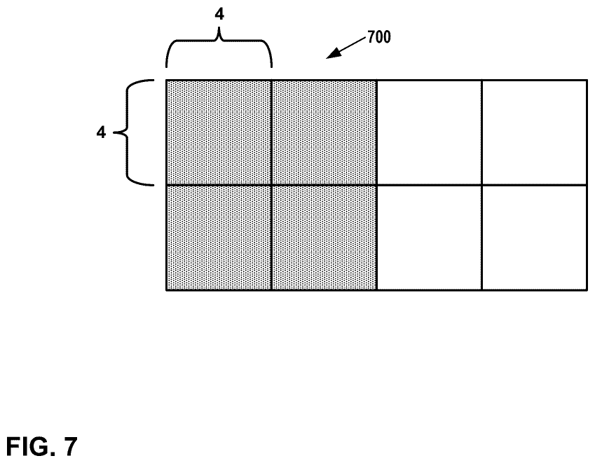

FIG. 7 is a conceptual diagram illustrating a ROI 700 for LFNST8. In other words, a ROI 700 for LFNST8 is shown in FIG. 7. The forward LFNST8 matrix can be R×64 and R is chosen to be 32. The generated coefficients are located in the same manner as with LFNST16.

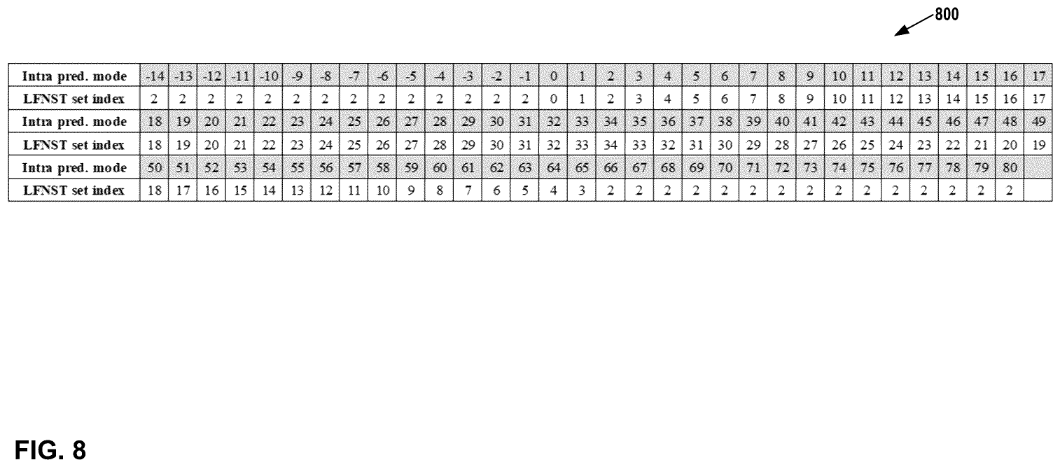

FIG. 8 is a table 800 illustrating a mapping of intra prediction modes to a low-frequency non-separable transform (LFNST) set index. The mapping from intra prediction modes to these LFNST kernel sets is shown in the table of FIG. 8. For example, for the intra prediction mode-14, an LFNST kernel set with LFNST set index 2 is used.

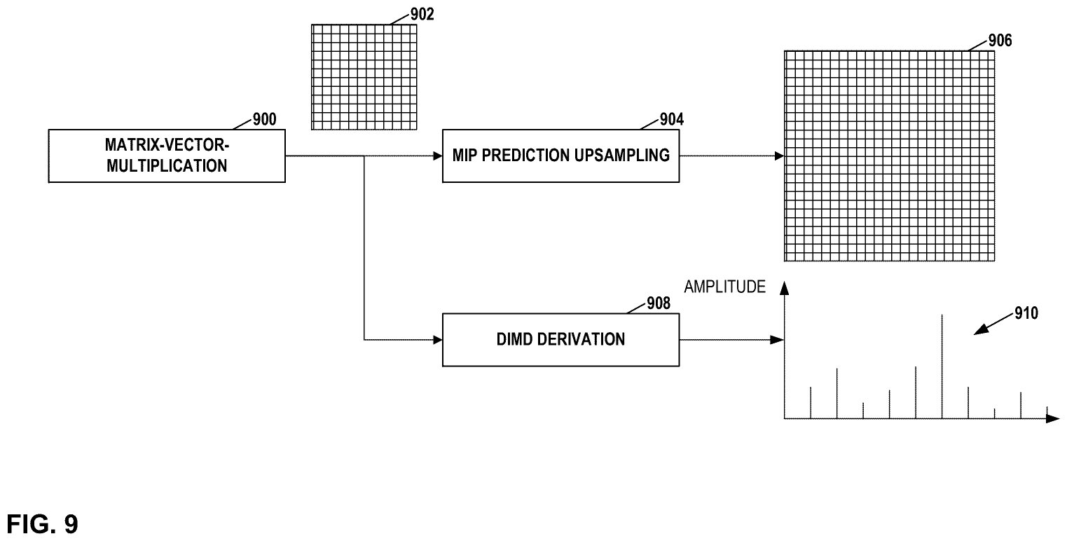

For blocks using MIP or IntraTMP prediction, the LFNST set index may be derived as follows. DIMD is used to derive the intra prediction mode of the current block based on the MIP or IntraTMP predicted samples. For MIP, this is done before upsampling. Specifically, a horizontal gradient and a vertical gradient are calculated for each predicted sample to build a HoG, as shown in FIG. 9. In other words, for each sample of the prediction block, a horizontal gradient value is calculated that indicates a rate of change at the sample of sample values in the horizontal direction and a vertical gradient value is calculated that indicates a rate of change at the sample of sample values in the vertical direction. A directional intra mode for the sample is determined based on the horizontal gradient value and the vertical gradient value is then determined. The HoG represents counts of directional intra prediction modes for the samples in the prediction block. The intra prediction mode with the largest histogram amplitude values is then used to determine the LFNST transform set and an LFNST Transpose flag. For example, video encoder 200 and video decoder 300 may use transposed kernels to generate predictions for a block of dimensions W×H with directional intra prediction mode 18 (horizontal mode) and a H×W block with directional intra prediction mode 50 (vertical mode) because of symmetry of these directional intra prediction modes. So, kernels for up to intra prediction mode 34 are defined, and a block of W×H with mode m (with m>34) will use the transposed kernel of H×W with mode (68−m). The transposition of the kernel may be indicated by an LFNST transpose flag (indicating kernel transpose is needed).

FIG. 9 is a conceptual diagram illustrating example Mapping from Intra Prediction (MIP) prediction samples to build a histogram of gradient (HoG). In the example of FIG. 9, video encoder 200 or video decoder 300 may first perform matrix-vector multiplication (900) to generate an initial block 902. Video encoder 200 or video decoder 300 may then perform MIP prediction upsampling (904) to generate an upsampled block 906. Additionally, video encoder 200 or video decoder 300 may perform DIMD derivation (908) to generate a HoG 910.

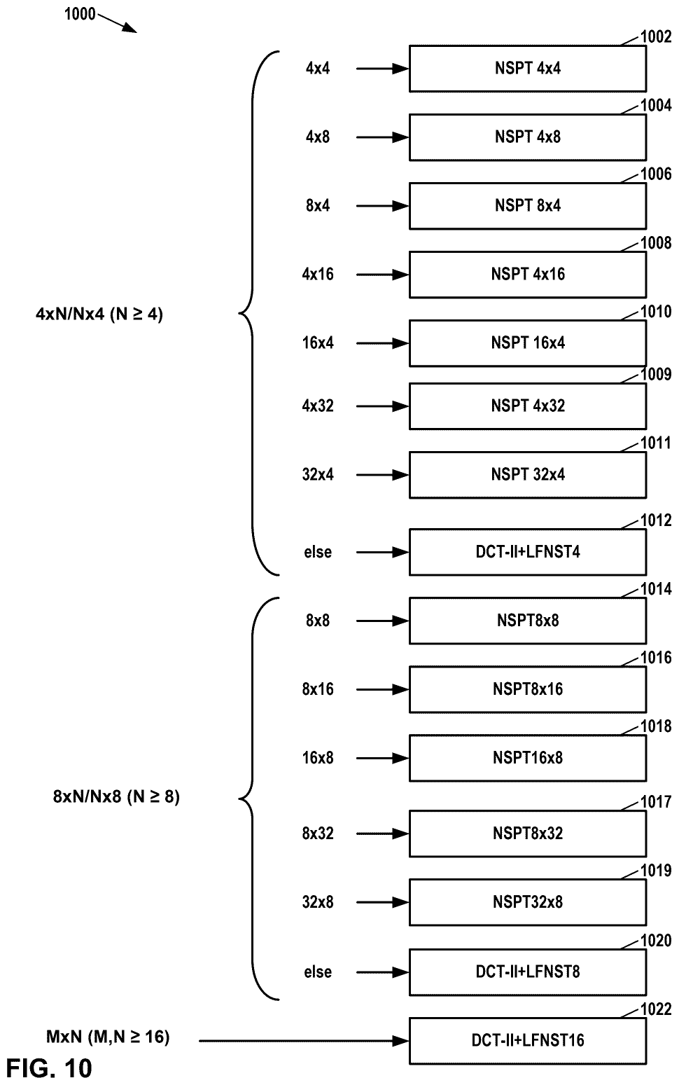

Non-separable primary transform (NSPT) for intra coding is now discussed. The separable DCT-II plus LFNST transform combinations are replaced with NSPT for the block shapes 4×4, 4×8, 8×4, 8×8, 4×16, 16×4, 8×16, 16×8, 4×32, 32×4, 8×32, and 32×8. The affected block sizes are summarized in FIG. 10. FIG. 10 is a conceptual diagram illustrating an overview of non-separable primary transforms (NSPTs) among existing LFNSTs. In other words, FIG. 10 shows an example of sets of kernels 1000 for NSPT. Sets of kernels 1000 includes three groups. A first group corresponds to transform block sizes of 4×N and N×4, where N is greater than or equal to 4 (e.g., 4×4, 4×8, 8×4, 4×16, 16×4, 4×32, and 32×4). A second group corresponds to transform block sizes of 8×N and N×8, where N is greater than or equal to 8 (e.g., 8×8, 8×16, 16×8, 8×32, and 32×8). A third group corresponds to transform block sizes of M×N, where M and N are greater than or equal to 16. In FIG. 10, a kernel 1002 (NSPT 4×4) corresponds to transform block size 4×4, a kernel 1004 (NSPT 4×8) corresponds to transform block size 4×8, a kernel 1006 (NSPT 8×4) corresponds to transform block size 8×4, a kernel 1008 (NSPT 4×16) corresponds to transform block size 4×16, a kernel 1010 (NSPT 16×4) corresponds to transform block size 16×4, a kernel 1009 (NSPT 4×32) corresponds to transform block size 4×32, a kernel 1011 (NSPT 32×4) corresponds to transform block size 32×4, and a kernel 1012 (DCT-II+LFNST4, i.e., DCT-II followed by LFNST-4) corresponds to other transform block sizes of 4×N/N×4 with N greater than or equal to 4. A kernel 1014 (NSPT 8×8) corresponds to transform block size 8×8, a kernel 1016 (NSPT 8×16) corresponds to transform block size 8×16, a kernel 1018 (NSPT 16×8) corresponds to transform block size 16×8, a kernel 1017 (NSPT 8×32) corresponds to transform block size 8×32, a kernel 1019 (NSPT 32×8) corresponds to transform block size 32×8, and a kernel 1020 (DCT-II+LFNST8) corresponds to other transform block sizes of 8×N/N×8 with N greater than or equal to 8. A kernel 1022 corresponds to block sizes M×N where M and N are greater than or equal to 16.

In some examples, all NSPTs include 35 kernel sets and 3 candidates (similar to the current LFNST). In other words, there may be 35 NSPT kernel sets, each including 3 candidate NSPT kernels. The 35 NSPT kernel sets correspond to 35 directional intra prediction modes (considering symmetry). The kernels of NSPTs have the following shapes:
NSPT4×4: 16×16
NSPT4×8/NSPT8×4: 32×20
NSPT8×8: 64×32
NSPT4×16/NSPT16×4: 64×24
NSPT8×16/NSPT16×8: 128×40
NSPT4×32/NSPT32×4: 128×20
NSPT8×32/NSPT32×8: 256×24

Therefore, 12, 32, 40 and 88 coefficients are zeroed-out using NSPT4×8/NSPT8×4, NSPT8×8, NSPT4×16/NSPT16×4 and NSPT8×16/NSPT16×8 respectively. For NSPT4×32/NSPT32×4 and NSPT8×32/NSPT32×8, remaining 108 and 232 positions in each transform block are zeroed-out, respectively.

LFNST and NSPT for inter coding is now discussed. For an inter coded block, an intra prediction mode is first derived according to the inter prediction block with a DIMD-like process applied to the prediction. Then, the derived intra prediction mode is used to select an LFNST/NSPT transform set and the transform is processed with the selected LFNST/NSPT kernel, like in the intra coding process.

The signaling of an inter LFNST/NSPT index is different from that of an intra LFNST/NSPT index. As noted above, the NSPTs may include 35 kernel sets and 3 candidates. Each of the candidates is an individual kernel. The LFNST/NSPT index indicates which candidate is used. 0 indicates no LFNST/NSPT, and {1,2,3} indicates which LFNST/NSPT candidate is to be used. So, this is not a transform set index but just to indicate which candidate in LFNST/NSPT set. The intra LFNST/NSPT index binarization employs two context coded bins for each symbol, while truncated unary code with different context models for inter LFNST/NSPT index coding is used. LFNST/NSPT index signaling is prohibited in the case of sub-block transform (SBT), of which index value is inferred as 0.

A fast encoding algorithm like inter MTS may be applied to reduce the encoding time. The last non-zero position is checked for signaling of an LFNST/NSPT index using luma component only. For a low-delay coding configuration, intra-LFNST/NSPT is enabled for only I-slice, and inter-LFNST/NSPT is enabled with the faster encoding option.

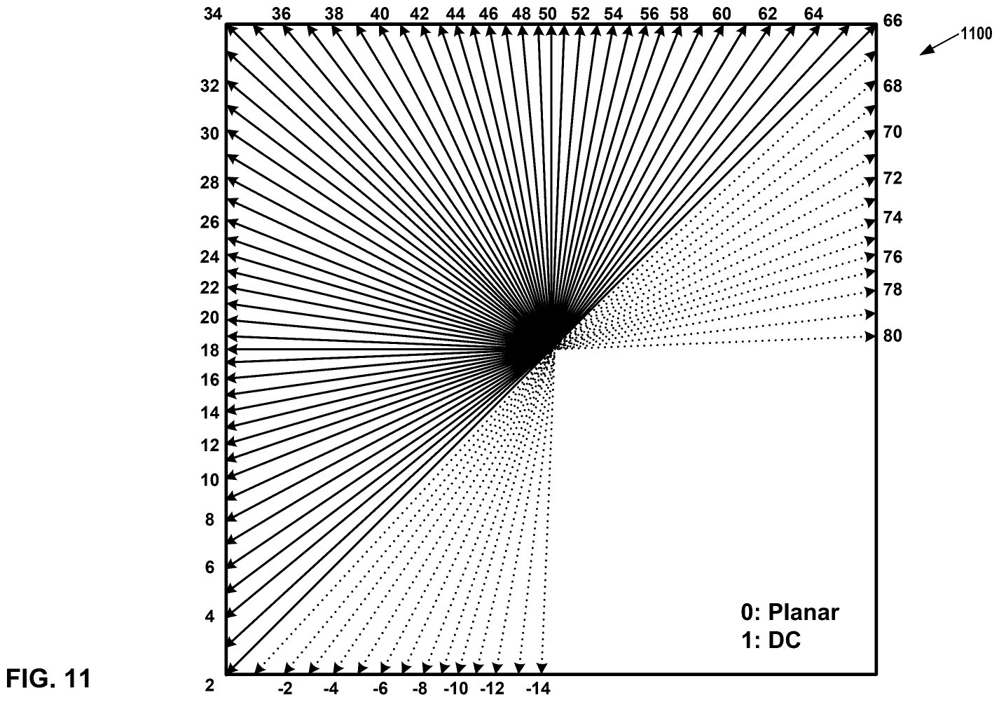

Directional intra prediction in VVC is now discussed. To capture the arbitrary edge directions presented in natural video, the number of directional intra modes in VTM5 is extended from 33, as used in HEVC, to 65. The new directional modes in VVC are depicted as in FIG. 11, and the planar and DC modes remain the same. These denser directional intra prediction modes apply for all block sizes and for both luma and chroma intra predictions. FIG. 11 is a conceptual diagram illustrating regular intra prediction modes 1100 in VVC Test Model (VTM) 7.0.

Conventional angular intra prediction directions are defined from 45 degrees to −135 degrees in a clockwise direction, which corresponds to mode 2 to mode 66 in FIG. 11. 5. To provide better prediction for non-square blocks, in VVC, the angles beyond 45 to −135 degrees are considered, which are shown in FIG. 11 for modes [67, 80], and mode [−1, −14]. For blocks with width (W) greater than height (H) modes [67, 80] are considered, and for blocks with width (W) less than height (H) modes [−1, −14] are considered. These directional intra prediction modes can be either used in combination with multiple reference lines (MRL), or with an intra-sub partition mode (ISP). The details can be found in G. J. Sullivan, J.-R. Ohm, W.-J. Han and T. Wiegand, “Overview of the High Efficiency Video Coding (HEVC) Standard,” IEEE Transactions on Circuits and Systems for Video Technology, vol. 22, no. 12, December 2012.

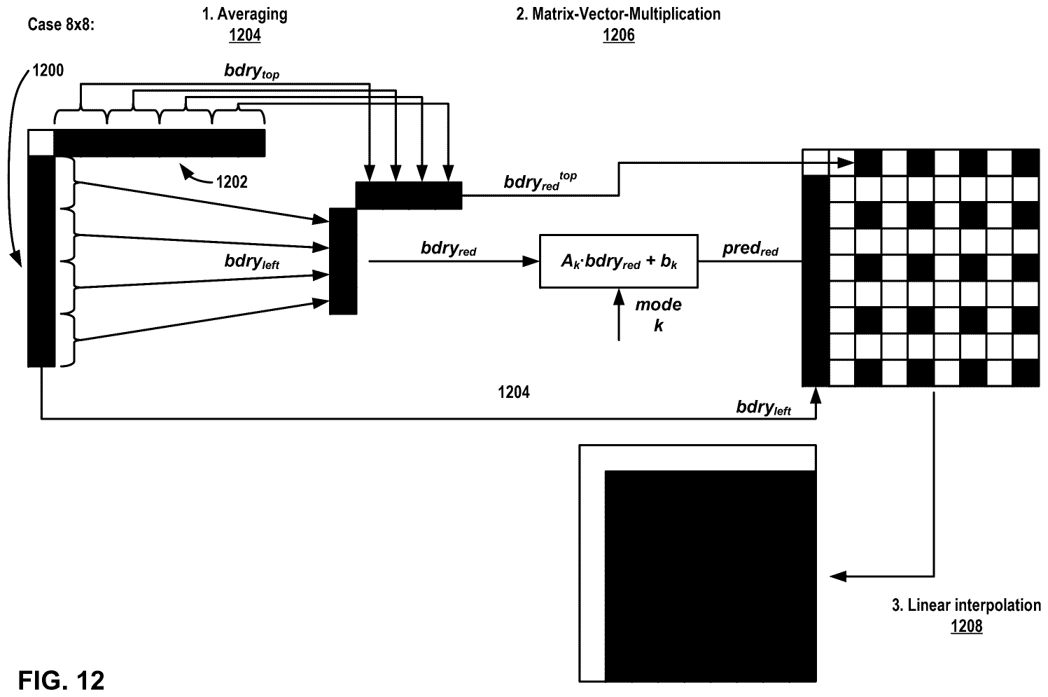

The matrix weighted intra prediction (MIP) method is an intra prediction technique introduced in VVC. FIG. 12 is a conceptual diagram illustrating an example matrix intra prediction process. To predict the samples of a rectangular block of width W and height H, matrix weighted intra prediction (MIP) takes one line of H reconstructed neighboring boundary samples left of the block 1200 and one line of reconstructed neighboring boundary samples above the block 1202 as input. If a reconstructed sample is unavailable, the reconstructed sample may be generated in the same way as conventional intra prediction. The generation of the prediction signal is based on the following three steps, which are averaging (1204), matrix vector multiplication (1206) and linear interpolation.

There are three different size Id is used for MIP process. An index is defined as follows. For idx=0, 1 and 2 there are 16, 12 and 6 matrices are defined, which also defines the number of modes for that given idx. Additionally, each mode is allowed to be transposed, where the samples from left and above are swapped before performing matrix-vector multiplication. So, additionally a transpose flag is signaled (along with the mode signaling) when a CU is coded with MIP.

Decoder side intra mode derivation and fused intra prediction (DIMD) is now discussed. In Abdoli et al., “Non-CE3: Decoder-side Intra Mode Derivation with Prediction Fusion Using Planar,” Video Experts Team (JVET) of ITU-T SG 16 WP 3 and ISO/IEC JTC 1/SC 29/WG 11, 22nd Meeting, by teleconference, 20-28 Apr. 2021, document JVET-O0449, intra prediction is performed based on decoder derived intra modes (using already decoded neighboring reconstructed samples) and fusing it with planar predicted samples. Two angular modes are selected from a Histogram of Gradient (HoG) computed from the neighboring pixels of current block. Once the two angular modes are selected, their predictors are computed using conventional angular intra prediction, and the final predictor of the block. The weights of the planar mode are kept at 21/64 (˜⅓) and the rest of 43/64 is distributed to two angular modes proportionally based on the corresponding amplitudes in the HoG. The HoG is computed by sliding 3×3 window on left and above neighbors reconstructed samples.

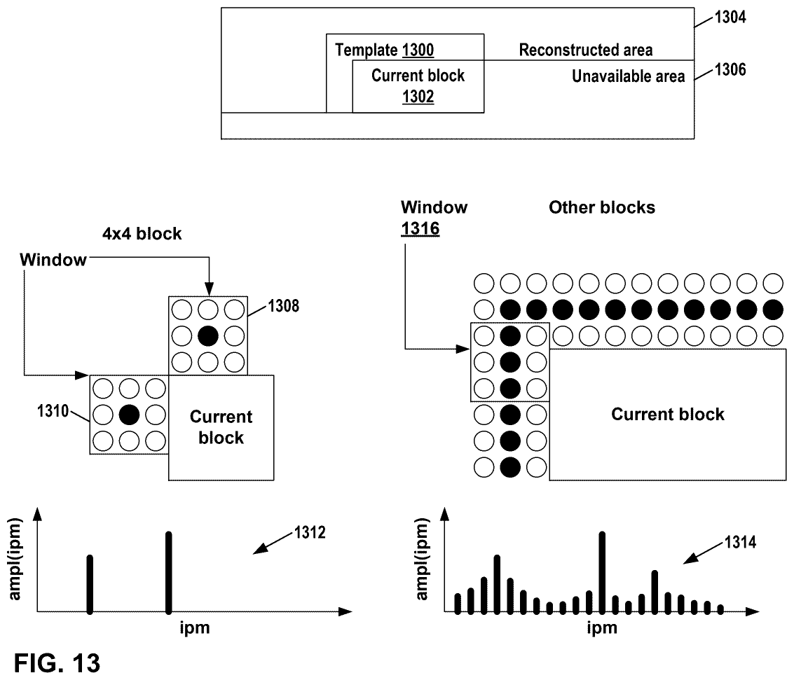

FIG. 13 is a conceptual diagram of HoG computation. In the example of FIG. 13, a template 1300 is located left and above a current block 1302. Template 1300 exists in a reconstructed area 1304 of a picture. An unavailable area 1306 exists below and to the right of current block 1302. If current block 1302 is a 4×4 block, template 1300 comprises an above reference sample set 1308 and a left reference sample set 1310, each comprising 3×3 samples. Video encoder 200 or video decoder 300 may generate a histogram of gradient 1312 based on above reference sample set 1308 and left reference sample set 1310. If current block 1302 has block dimensions other than 4×4, a HoG 1314 is computed by sliding 3×3 window 1316 on left and above neighbors reconstructed samples.

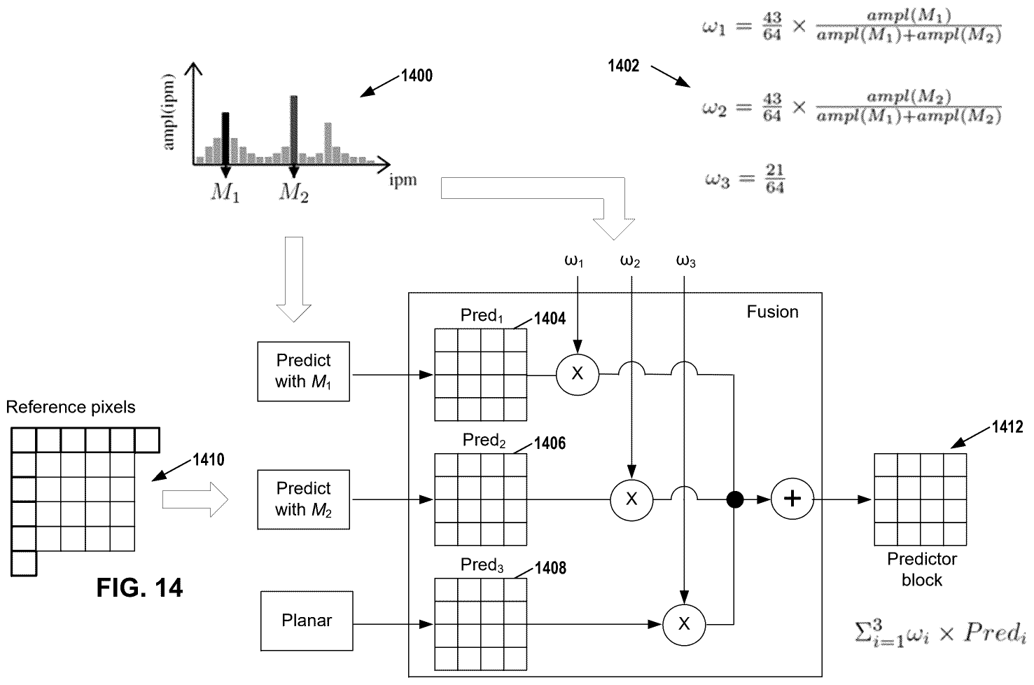

FIG. 14 is a conceptual diagram of weight determination and final predictor generation. In the example of FIG. 14, an M₁ directional intra mode and an M₂ directional intra mode are determined using HoG 1400. Weights ω₁, ω₂, and ω₃ are determined based on the amplitudes of M₁ and M₂ as shown in equations 1402. Additionally, prediction blocks 1404, 1406, and 1408 are determined for a current block 1410 using the M₁ directional intra mode, the M₂ directional intra prediction mode, and a planar intra mode. Prediction blocks 1404, 1406, and 1408 are then multiplied by the corresponding weights ω₁, ω₂, and ω₃ and the results are summed to generate a predictor block 1412.

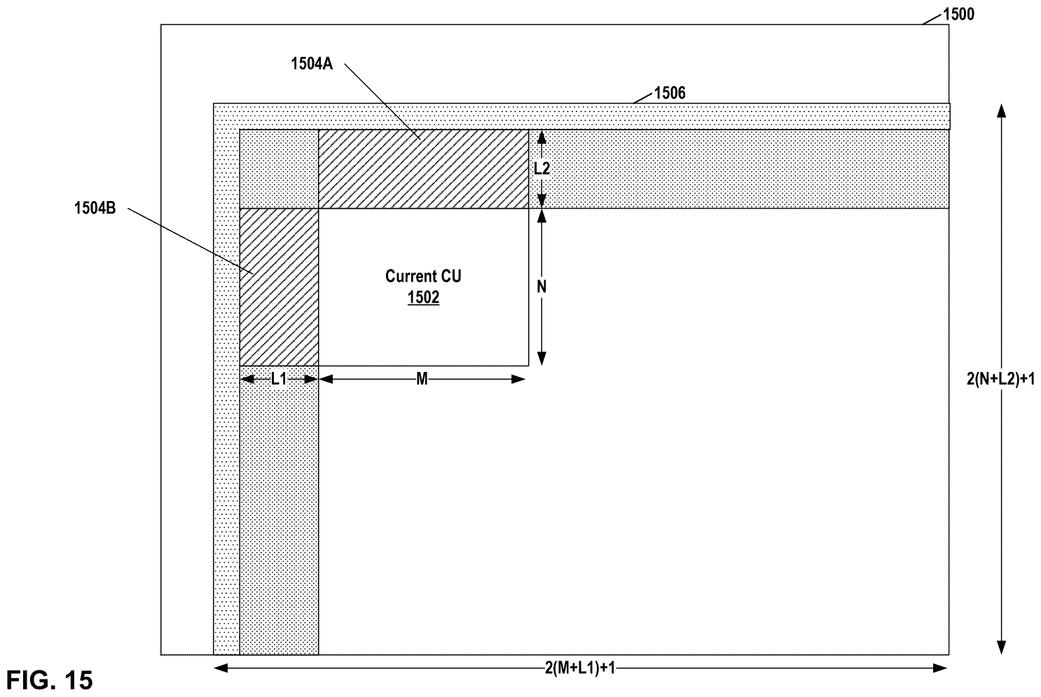

Template-based intra mode derivation with fusion (TIMD) is now discussed. In Wang et al., “EE2-related: Template-based intra mode derivation using MPMs,” JVET-V0098, another decoder-side intra mode derivation method is proposed as a template-based intra mode derivation. The idea for TIMD is shown in FIG. 15. FIG. 15 is a conceptual diagram illustrating an example template and reference samples used in template-based intra model derivation with fusion (TIMD). In the example of FIG. 15, a picture 1500 includes a current CU 1502. Two template regions 1504A, 1504B are chosen (above the current CU 1502 and left of the current CU 1502) and a reference of template 1506 is chosen correspondingly. For each mode in the MPM list, prediction is generated for the template region and sum of absolute transformed distances (SATD) cost is computed on the template region between the prediction and the reconstruction samples. The mode with the lowest cost is chosen as the mode for TIMD. Also, the number of angular intra modes (including wide angle modes) are extended (doubled) compared to VVC, i.e., the angles are twice densely arranged.

Furthermore, in Cao et al., “EE2-related: Fusion for template-based intra mode derivation,” Video Experts Team (JVET) of ITU-T SG 16 WP 3 and ISO/IEC JTC 1/SC 29/WG 11, 23rd Meeting, by teleconference, 7-16 Jul. 2021, JVET-W0123, fusion for TIMD is proposed. That is, instead of selecting the only one mode with the smallest SATD cost, this contribution proposes to choose the first two modes with the smallest SATD costs for the intra modes derived using TIMD method and then fuse them with the weights, and such weighted intra prediction is used to code the current CU. The costs of the two selected modes are compared with a threshold, in the test the cost factor of 2 is applied as follows:

$$costMode 2 < 2 * costMode 1.$$

If this condition is true, the fusion is applied, otherwise the only model is used.

Weights of the modes are computed from their SATD costs as follows:

$$weight 1 = costMode 2 / ( costMode 1 + costMode 2 )$$

$$weight 2 = 1 - weight 1$$

Furthermore, in Andrivon et al., “EE2-1.20: TIMD fusion with non-angular predictor, Video Experts Team (JVET) of ITU-T SG 16 WP 3 and ISO/IEC JTC 1/SC 29/WG 11, 33rd Meeting, by teleconference, 17-26 Jan. 2024, JVET-AG0092, the third fusion candidate is introduced, which is always a non-angular intra prediction mode. The conditions below are checked to determine whether the non-angular intra prediction mode is used in fusion:
(1) the non-angular intra prediction mode is different from the two selected intra prediction modes.
(2) costMode3<1.5*costMode1, where the costMode3 is the SATD cost of the non-angular intra prediction mode and costMode1 is the SATD cost of the first intra prediction mode.

If both conditions are true, three intra prediction modes are used to generate the prediction. The weights of each intra prediction mode are computed from SATD cost:

$${weight}_{i} = \frac{sumSATD - {costMode}_{i}}{2 \times sumSATD} , sumSATD = {\sum }_{j = 1}^{3} {costMode}_{i} .$$

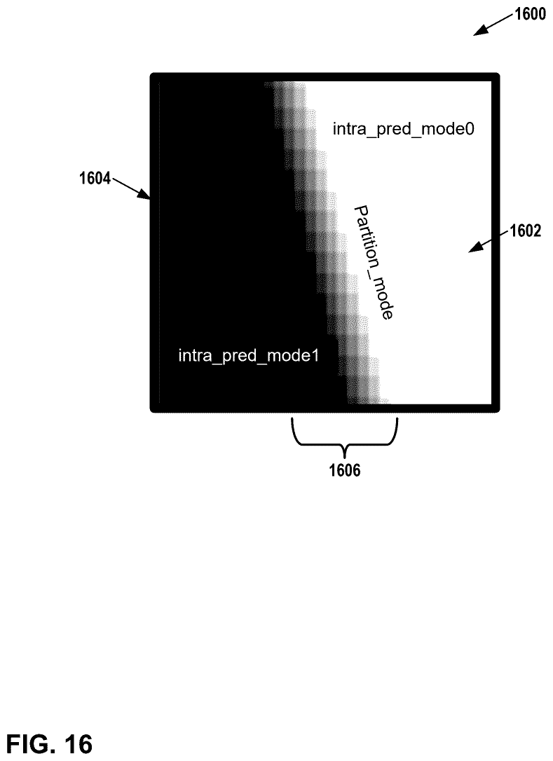

Spatial geometric partitioning mode (SGPM) is now discussed. SGPM is an intra mode that resembles the inter coding tool of geometric partitioning mode (GPM), where the two prediction parts are generated from an intra predicted process. In this mode, a candidate list is built with each entry containing one partition split and two intra prediction modes. 26 partition modes and 9 of intra prediction modes are used to form the combinations. The length of the candidate list is set equal to 16. The selected candidate index is signaled. FIG. 16 is a conceptual diagram illustrating an example of spatial geometric partitioning mode. In FIG. 16, samples of a prediction unit 1600 include a first prediction part 1602 and a second prediction part 1604. Samples in the first prediction part 1602 are generated using a first intra prediction process. Samples in the second prediction part 1604 are generated using a second intra prediction process. Samples in a transition zone 1606 are a blend of samples generated using the first intra prediction process and samples generated using the second intra prediction process.

In the current ECM design, an NSPT kernel set is chosen implicitly based on the applied or derived intra mode and the transform block size. LFNST is mostly used with 16×16 kernels after the introduction of NSPT, and a kernel set is chosen implicitly based on the applied or derived intra mode and does not depend on the transform block size. A kernel in a set is chosen explicitly. This design does not provide sufficient adaptation to the content, since the input statistic may vary significantly for each kernel.

In accordance with techniques of this disclosure, various methods are disclosed to define an improved non-separable transform kernel choice. The elements of the described techniques may be used independently or in any combination.

In accordance with one or more techniques of this disclosure, an NSPT/LFNST kernel set choice may be dependent on prediction type. A kernel set is a set of kernels. For ease of explanation, this disclosure may use the term non-separable transform kernel set to refer to either an NSPT kernel set or a LFNST kernel set.

A NSPT/LFNST kernel choice may depend on the prediction type, including but not restricted to: Directional intra prediction, TIMD, DIMD, SGPM, EIP, MIP, ITMP, IBC, Non-affine inter prediction, Affine inter prediction. In other words, video encoder 200 and video decoder 300 may select, based on a prediction type associated with a transform block, an NSPT kernel or a LFNST kernel from a NSPT kernel set or a LFNST kernel set. In general, a “prediction type” is a process for generating a prediction block. The term “prediction type” does not refer to individual intra prediction modes that are usable within the directional intra prediction type. Rather, this disclosure uses the term intra prediction mode to refer to individual directional intra prediction modes. Directional intra prediction modes may include directional modes, a planar mode and a DC mode. A “prediction type” indicates the nature of prediction or the way prediction is carried out. Example prediction types include regular intra prediction, fusion (e.g., DIMD/TIMD), partition-based prediction like SGPM (where block is partitioned into two parts, and each part is predicted independently), inter prediction, intra template matching prediction etc.). A transform block may be associated with a prediction type if a prediction block that was used to generate residual data on which the transform block is based was generated using prediction mode. A transform block may be associated with an intra prediction mode if a prediction block that was used to generate residual data on which the transform block is based was generated using the intra prediction mode.

In one example, given fixed transform block dimensions, a separate NSPT/LFNST set is defined and chosen for each combination of a prediction type and an intra prediction mode. In other words, for a single fixed set of transform block dimensions, video encoder 200 and video decoder 300 may store a plurality of separate non-separable kernel sets associated with a plurality of different combinations of prediction types and intra prediction modes. Video encoder 200 and video decoder 300 may determine the non-separable transform kernel set based on the prediction type associated with the transform block and an intra prediction mode associated with the transform block. For example, a first non-separable transform kernel set may be defined for a combination of a first prediction type and a first intra prediction mode, a second non-separable transform kernel set may be defined for a combination of the first prediction type and a second intra prediction mode, a third non-separable transform kernel set may be defined for a combination of a second prediction type and the first intra prediction mode, and so on.

The ability to adaptively select a kernel set based on a prediction type associated with a transform block, as opposed to having the kernel set be selected based only on an applied or derived intra mode and the transform block size, may enable video encoder 200 and video decoder 300 to select the kernel set adaptively. As previously noted, residual characteristics vary based on how the prediction is done (even when associated intra prediction mode or dominant intra prediction is the same), for example, regular intra prediction vs fusion based intra prediction). Because the residual characteristics vary based on how the prediction is done, being able to select the kernel set adaptively in this way may increase compression efficiency, reducing the amount of data in the bitstream for representing the transform coefficients while maintaining quality (e.g., loss/distortion). In other words, the kernel set may be adaptively selected to increase compression efficiency.

In some examples, given fixed transform block dimensions, a NSPT/LFNST kernel set is defined for a subset of combinations of a prediction type and an intra prediction mode, in order to limit the additional number of kernels. In other words, a non-separable transform kernel set is associated with fixed transform block dimensions and is defined for a subset of combinations of prediction types and intra prediction modes. Thus, video encoder 200 and video decoder 300 may determine the non-separable kernel set based on a block having specific fixed transform block dimensions and having a specific combination of a prediction type and an intra prediction mode. Selecting the non-separable kernel set based on the block having specific fixed transform block dimensions and having a specific combination of a prediction type and an intra prediction mode allow video encoder 200 and video decoder 300 to ultimately select a kernel that is able to represent the transform block more efficiently. For example, given fixed transform block dimensions and an intra prediction mode, two NSPT/LFNST kernel sets are defined, where one set is used for TIMD, DIMD and SGPM and another set is used elsewhere. For example, instead of having 35 sets (indicating 35 intra direction modes), there can be 35(modes)*2(whether DIMD/TIMD/SGPM or not)=70 sets.

In some examples, a primary set of LFNST/NSPT kernels (i.e., a primary LFNST/NSPT kernel set) is defined only for all applicable block shapes (i.e., a predefined set of block shapes) and an additional, secondary NSPT/LFNST kernel set is only defined for certain block shapes and certain prediction types. For instance, in some examples, the secondary NSPT/LFNST kernel set is only defined for blocks with width<=16 and height<=16 and not both equal to 16, and when the prediction type is either DIMD, TIMD or SGPM. Thus, video encoder 200 and video decoder 300 may determine a non-separable transform kernel set from among a primary kernel set and a secondary kernel set, wherein the primary kernel set is defined for all applicable block shapes, and the secondary kernel set is defined for one or more specific block shapes and prediction types. In other words, video encoder 200 and video decoder 300 may use the secondary kernel set for specific combinations of block shapes and prediction types, and may use the primary kernel set in other circumstances regardless of block shape. Alternatively, in another example, this additional kernel set is defined for a subset of intra prediction modes in combination with certain intra prediction types. In another example, this block shape and intra-prediction mode restriction can be applied together. In this example, the additional, secondary NSPT/LFNST kernel set is only applicable to certain block sizes and certain intra prediction modes. For instance, video encoder 200 and video decoder 300 may just use a subset of modes (e.g., 20 modes instead of 35 modes) where additional, secondary NSPT/LFNST sets are defined. The idea here is having an additional set for only most useful mode, to reduce the additional storage of kernels.

In some examples, the number of output coefficients for NSPT for the different set may be different than the quantity of output coefficients NSPT for the primary NSPT kernel set. In other words, application of NSPT kernels in the secondary NSPT kernel set may produce a first number of output coefficients and application of NSPT kernels in the primary NSPT kernel set may produce a second number of output coefficients different from the first number of output coefficients. For example, for 8×16/16×8, the primary NSPT kernel set may have 40 output coefficients (as in ECM), however the additional NSPT kernel set for 8×16/16×8 may have output coefficients which is different than 40.

In some examples, the additional, secondary kernel set is designed only for NSPT. For instance, video encoder 200 and video decoder 300 may use the primary kernel set for NSPT or LFNST and may use the secondary kernel set for NSPT. Thus, video encoder 200 and video decoder 300 may only use the primary kernel set for LFNST. In at least some such examples, there is no secondary kernel set defined for LFNST.

In some examples, the LFNST kernel set choice is dependent on transform block dimensions. For instance, video encoder 200 and video decoder 300 may select a first LFNST kernel set for a 4×4 transform blocks and a second LFNST kernel set for 8×8 transform blocks. In some examples, LFNST kernel set is chosen implicitly based on the intra mode and transform block dimensions. For example, video encoder 200 and video decoder 300 may select a first LFNST kernel set when a transform block is associated with a first intra mode and has first transform block dimensions, may select a second LFNST kernel set when the transform block is associated with a second intra mode and has the first transform block dimensions, and so on. As noted above, an NSPT kernel set may be chosen implicitly based on the applied or derived intra mode and the transform block size, but the LFNST kernel set is chosen implicitly based on the applied or derived intra mode and does not depend on the transform block size. Having the LFNST kernel set choice be further dependent on the transform block dimensions may enable video encoder 200 and video decoder 300 to select an LFNST kernel that is more appropriate for a transform block, thereby increasing coding efficiency. The techniques of this disclosure in which the LFNST kernel set choice is dependent on transform block dimensions may be used in combination with or independently of other techniques described in this disclosure.

In some examples, an LFNST region of interest (ROI) is dependent on prediction type or transform block dimensions. For example, video encoder 200 and video decoder 300 may use differently sized and/or shaped LFNST ROIs for a transform block depending on a prediction type associated with the transform block and/or dimensions of the transform block. The ROI may be defined differently for blocks applying transforms of the same matrix dimensions, but different prediction types and/or having different transform block dimensions. LFNST is applied on top of primary transform coefficients (DCT2 coefficients). However, only a subset of primary coefficients (typically low frequency coefficients), called ROI or region of interest, are used as an input for LFNST. The ROI basically only keeps the useful coefficients or pattern of useful frequencies and discards the other coefficients (by setting to 0). Thus, the ROI reduces storage and computational complexity. In ECM, this ROI is coarsely determined based on block-shape or block dimension. Coarsely because, only three different ROI is defined, and one ROI can be shared across multiple transform block dimension. In accordance with one or more techniques of this disclosure, the LFNST ROI may be dependent on the prediction type or transform block dimensions, because the pattern of useful frequencies may vary based on prediction types. For example, if LFNST8 is applied to blocks 8×8 and 8×32, both would currently apply a square ROI of 8×8 primary transform coefficients. In another example, it may be beneficial to define ROI as 4×16 for blocks 8×32. The techniques of this disclosure in which the LFNST ROI is dependent on prediction type or transform dimensions may be used in combination with or independently of other techniques described in this disclosure.

In some examples, given an intra prediction mode, two blocks having different dimensions but using transform matrices (i.e., kernels) of the same dimensions, may use different ROI disposition in the transform block. In other words, for a first transform block and a second transform block that have different dimensions and transform matrices of the same dimensions, video encoder 200 and video decoder 300 may use ROIs disposed at different locations within the first and second transform blocks. For example, transform blocks having dimensions 16×16 and 16×32 may both use kernels of size 32×96, though the ROI, defining the forward transform input values and the inverse transform output values, may be different.

NSPT/LFNST shared kernel usage between several prediction types and/or several intra modes and/or several block dimensions is now described. In some instances, the techniques described above with respect to NSPT/LFNST kernel set choice are dependent on prediction type and with respect to LFNST kernel set choice dependent on transform block dimensions may increase memory consumption for storing kernels. To favor memory requirements, the kernel amount (e.g., number of kernels in a kernel set) can be efficiently reduced using the technology described in the following section of this disclosure. Techniques of this disclosure in which there is shared kernel usage between multiple prediction types and/or intra modes may be used with or independently of any other technique of this disclosure.

In some examples, there may be NSPT/LFNST shared kernel usage between several prediction types. Sharing kernels between prediction types may reduce the number of kernels stored by video encoder 200 and video decoder 300, which may reduce complexity and costs of video encoder 200 and video decoder 300. For instance, in a case of a NSPT/LFNST kernel set choice dependent on prediction type, a shared NSPT/LFNST kernel may be included in the NSPT/LFNST kernel sets that associated with two or more different prediction types and the same specific intra mode and block dimensions. This shared NSPT/LFNST kernel may be associated with individual candidate indexes, e.g., because the frequency with which the shared NSPT/LFNST kernel is selected may vary dependent on the candidate index. In one example, kernel sharing may be applied across kernel sets for candidates with indexes 2 and 3, but not for candidates with index 1.

In some examples, there are at least two prediction types applying the same transform kernel, while another prediction type may require choosing a different kernel, given the same intra mode and block dimensions set. In other words, video encoder 200 and video decoder 300 may determine a non-separable transform kernel set based on a prediction type of the transform block, a kernel is selectable for transform units (e.g., transform blocks) that (i) are associated with a set of prediction types that includes two or more different prediction types and (ii) are associated with a same specific intra mode and same specific block dimensions.

In some examples, there are at least two prediction types applying the same transform kernel, given specific intra mode and block dimensions, while the same prediction types may require choosing various kernels that are different from one another, given another intra mode and/or other block dimensions set. For example, blocks 1 and 2 may have the same intra mode and block shape, and share an NSPT/LFNST kernel, even though their prediction types differ. In this example, block 3 has the same prediction type as block 1, while an intra mode and/or block dimension of block 3 differ from the intra mode and/or block dimension of block 1. In this example, block 4 has the same prediction type of block 2, intra mode and blocks dimensions are the same for blocks 3 and 4, though at least one of these parameters differs from the one shared between blocks 1 and 2, blocks 3 and 4 use different kernels here.

Hence, in some examples, video encoder 200 and video decoder 300 may determine a non-separable transform kernel set, select, based on a prediction type associated with the transform block, a first kernel from the kernel set, and apply a first non-separable transform to a first transform block using the first kernel. In this example, to determine the first kernel, video encoder 200 and video decoder 300 may determine, based on an intra mode associated with the first transform block, the first kernel from the kernel set. Additionally, in this example, video encoder 200 and video decoder 300 may select, based on an intra mode associated with a second transform block, the first kernel from the kernel set. The first transform block and the second transform block are associated with different prediction types, both have same block dimensions, and the intra mode associated with the first transform block is the same as the intra mode associated with the second transform block. In this example, video encoder 200 and video decoder 300 may apply the first non-separable transform to the second transform block using the first kernel. Video encoder 200 and video decoder 300 may select, based on an intra mode associated with a third transform block, a second kernel from the kernel set. A prediction type associated with the third transform block is the same as the prediction type associated with the first transform block, and at least one of: (i) the intra mode associated with the third transform block is different from the intra mode associated with the first transform block or (ii) block dimensions of the third transform block are different from the block dimensions of the first transform block.

In some examples, prediction types applying blending (for example, but not restricted to TIMD, DIMD) and/or types having specific statistics (for example, but not restricted to EIP, MIP), types applying subblock prediction (e.g., SGPM) and Inter types (including affine and non-affine predictions, as well as ITMP and IBC having a similar idea for prediction, but referencing the same picture) can share kernels within the aforementioned groups or between the aforementioned groups, opposed to other type groups or to directional intra prediction, applying other transform kernels. Thus, in some examples, a first set of prediction types includes two or more of: prediction types that apply blending, EIP, MIP, prediction types that apply subblock prediction, and inter prediction types, and a second set of prediction types includes directional intra prediction.

One or more techniques of this disclosure provide for NSPT/LFNST shared kernel usage between several intra modes. For example, one NSPT/LFNST kernel may be chosen for two or more different intra modes, given specific prediction type and block dimensions. For example, a first transform block and a second transform block are associated with same set of a prediction type and block dimensions and different intra modes. In this example, video encoder 200 and video decoder 300 may select, based on an intra mode associated with a first transform block, a first kernel from a kernel set. In this example, video encoder 200 and video decoder 300 may select, based on an intra mode associated with a second transform block, the first kernel from the kernel set. Video encoder 200 and video decoder 300 may apply a non-separable transform to the second transform block using the second kernel. Techniques of this disclosure in which there is shared kernel usage between multiple intra modes may be used with or independently of any other technique of this disclosure.

In some examples, there are at least two intra modes applying the same transform kernel, while another intra mode may require choosing a different kernel, given the same prediction type and block dimensions set. For example, a first transform block and a second transform block have a same set of a prediction type and block dimensions. In this example, video encoder 200 and video decoder 300 may select, based on an intra mode associated with a first transform block, a first kernel from a kernel set, wherein the first kernel is applicable to at least two intra modes. In this example, video encoder 200 and video decoder 300 may select, based on an intra mode associated with a second transform block, a second kernel from the kernel set, wherein the intra mode associated with the second transform block is not one of the at least two intra modes. Video encoder 200 and video decoder 300 may apply a non-separable transform to the second transform block using the second kernel.

In one example, there are at least two intra modes applying the same transform kernel, given specific prediction type and block dimensions, while the same intra modes may require choosing various kernels, given another prediction type and/or other block dimensions set. For example, a transform block 1 and a transform block 2 are both associated with a first prediction type, both have same block dimensions, and an intra mode associated with the transform block 1 is different from an intra mode associated with the transform block 2. In this example, video encoder 200 and video decoder 300 may determine, based on the intra mode associated with a transform block 1, a first kernel from a kernel set. In this example, video encoder 200 and video decoder 300 may select, based on the intra mode associated with a transform block 2, the first kernel from the kernel set. Video encoder 200 and video decoder 300 may apply the first non-separable transform to the transform block 2 using the first kernel. Furthermore, in this example, video encoder 200 and video decoder 300 may select, based on an intra mode associated with a transform block 3, a second kernel from the kernel set, and, based on an intra mode associated with a transform block 4, a third kernel from the kernel set. In this example, block 3 has the same intra mode as block 1, while an intra mode and/or block dimension of block 3 differ from the intra mode and/or block dimension of block 1. In this example, block 4 has the same intra mode as block 2, prediction type and blocks dimensions are the same for blocks 3 and 4, though at least one of these parameters differs from the one shared between blocks 1 and 2, blocks 3 and 4 use different kernels here. Video encoder 200 and video decoder 300 may apply a second non-separable transform to the transform block 3 using the second kernel and a third non-separable transform to the transform block 4 using the third kernel.

In one example, several subsequent (similar) intra modes may share one kernel. For example, mode 50 and mode 51 may share one kernel as the residual characteristics can be similar.

Some examples provide for LFNST shared kernel usage between several block dimensions. For instance, in cases where LFNST kernel set choice is dependent on block dimensions, one LFNST kernel may be chosen for two or more different block dimensions, given a specific intra mode and prediction type. In other words, the same LFNST kernel may be used for both a first transform block and a second transform block if the first and second transform blocks have different dimensions but have the same intra mode and prediction type. In some examples, there are at least two block dimensions applying the same transform kernel, while other block dimensions may require choosing a different kernel, given the same intra mode and prediction type set. For example, a first transform block and a second transform block may have different block dimensions but video encoder 200 and video decoder 300 may apply a non-separable transform to the first and second transform blocks using the same kernel. In this example, a third transform block may have block dimensions different from the first and second transform blocks but has the same intra mode and prediction type as the first and second transform blocks. Video encoder 200 and video decoder 300 may apply a non-separable transform to the third transform block using a kernel different from that used for the first and second transform blocks. Techniques of this disclosure in which there is LFNST shared kernel usage between multiple block dimensions may be used with or independently of any other technique of this disclosure.

In some examples, there are at least two block dimensions applying the same transform kernel, given specific intra mode and block dimensions, while the same block dimensions may require choosing various kernels, given another intra mode and/or another prediction type set. For example, a transform block 1 may have first block dimensions and a transform block 2 may have second block dimensions different from the first block dimensions, the first transform block and the second transform block are associated with a first intra mode and/or a first prediction type. In this example, video encoder 200 and video decoder 300 may apply a non-separable transform based on the same first kernel to the transform block 1 and the transform block 2. Furthermore, in this example, a transform block 3 may have the first block dimensions but may be associated with a different intra mode or prediction type than the transform blocks 1 or 2. In this example, a transform block 4 may have the second block dimensions but may be associated with the same intra mode and prediction type as transform block 3. Blocks 3 and 4 use different kernels here. In this case, video encoder 200 and video decoder 300 may apply a non-separable transform based on a second kernel different from the first kernel.

Some examples provide for NSPT/LFNST kernel amounts to be dependent on block dimensions. The total amount of different kernels chosen for fixed block dimensions, but for various prediction types and various intra modes, can be variable and dependent on block dimensions. For example, video encoder 200 and video decoder 300 may select a first non-separable transform kernel set based on a transform block having first block dimensions and may select a second non-separable transform kernel set based on a transform block having second block dimensions different from the first block dimensions. In this example, video encoder 200 and video decoder 300 may select kernels from the first and second non-separable transform kernel sets for applying non-separable transforms to the first and second transform blocks. The first and second non-separable transform kernel sets may include different numbers of kernels. Techniques of this disclosure in which the NSPT/LFNST kernel amounts are dependent on block dimensions may be used with or independently of any other technique of this disclosure.

In some example, smaller kernel sets are defined for larger block dimensions to decrease memory consumption. For example, video encoder 200 and video decoder 300 may select a first non-separable transform kernel set for 16×16 transform blocks and a second non-separable transform kernel set for 8×8 blocks. In this example, the first non-separable transform kernel set may have fewer kernels than the second non-separable transform kernel set. Having the number of kernels be dependent on block dimensions may reduce storage requirements because kernels for larger block dimensions may require greater storage resources than the same number of kernels for smaller block dimensions.

In one example, smaller kernel sets are defined for less-used block dimensions, for example, for non-square blocks. For example, video encoder 200 and video decoder 300 may select a first non-separable transform kernel set for 16×16 transform blocks and a second non-separable transform kernel set for 8×8 blocks. In this example, assuming that transform blocks of size 16×16 are less common than transform blocks of size 8×8, the first non-separable transform kernel set may have fewer kernels than the second non-separable transform kernel set. Having the number of kernels be dependent on how frequently the block dimensions are used may reduce storage requirements because relatively fewer kernels may need to be stored for less-used block dimensions.

The described elements may be used independently or in any combination.

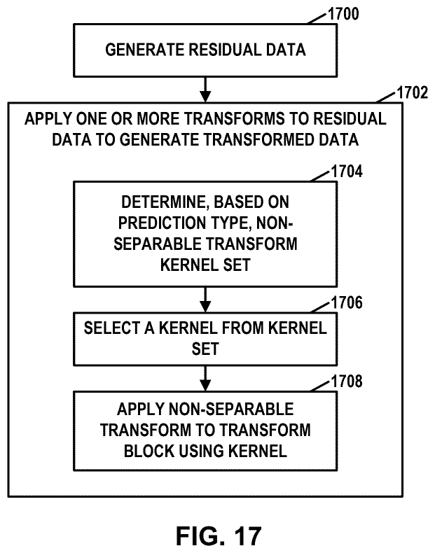

FIG. 17 is a flowchart illustrating an example operation of video encoder 200, in accordance with one or more techniques of this disclosure. In the example of FIG. 17, video encoder 200 (e.g., residual generation unit 204) may generate residual data based on a block of video data (e.g., a CU) and a prediction block (e.g., one or more PUs) (1700). For example, video encoder 200 may generate one or more prediction blocks associated with a CU using intra prediction or another prediction type. Video encoder 200 may generate the residual data by subtracting samples in the CU from corresponding samples in the one or more prediction blocks.

Additionally, video encoder 200 (e.g., transform processing unit 206) may apply one or more transforms to the residual data to generate transformed data of a transform block (1702). For example, video encoder 200 may generate one or more transform blocks corresponding to a CU. A prediction type associated with a transform block is a prediction type used to generate a prediction block of a CU associated with the transform block. Similarly, an intra prediction mode associated with a transform block is an intra prediction mode used to generate a prediction block of a CU associated with the transform block.

As at least part of applying the one or more transforms, video encoder 200 may determine, based on a prediction type associated with a transform block, a non-separable transform kernel set (1704). The non-separable transform kernel set may be a NSPT kernel set or an LFNST kernel set. For example, video encoder 200 may determine a first non-separable transform kernel set if the prediction type associated with the transform block is template-based intra mode derivation with fusion, decoder-side intra mode derivation (DIMD), spatial geometric partitioning mode (SGPM), extrapolation filter-based intra prediction (EIP), matrix-based intra prediction (MIP), intra template matching prediction (ITMP), intra block copy (IBC), non-affine inter prediction, or affine inter prediction, and a second non-separable transform kernel set if the prediction type is a directional intra prediction mode.

In some examples, video encoder 200 may further determine the non-separable transform kernel set based on block dimensions of a transform block. In some such examples, video encoder 200 may determine the same non-separable transform kernel set for two or more transform blocks having different block dimensions. Different non-separable transform kernel sets may include different numbers of kernels. For instance, non-separable transform kernel sets associated with larger block dimensions may have smaller number of kernels than non-separable transform kernel sets associated with smaller block dimensions; or non-separable transform kernel sets associated with less-used block dimensions may have smaller number of kernels than non-separable transform kernel sets associated with more-used smaller block dimensions. In some examples, video encoder 200 determines the non-separable transform kernel set from a primary kernel set and a secondary kernel set. The primary kernel set may be defined for all applicable block shapes. The secondary kernel set may be defined for one or more specific block shapes and prediction types. In some examples, the secondary kernel set is defined only for a non-separable primary transform.

Additionally, video encoder 200 may select a kernel from the non-separable transform kernel set (1706). For example, video encoder 200 may evaluate results of applying two or more kernels in the non-separable transform kernel set to determine which kernel has better results. Video encoder 200 may signal an index of the selected kernel in a bitstream.

Video encoder 200 may then apply a non-separable transform to the transform block using the kernel (1708). For example, video encoder 200 may multiply transform coefficients in the transform block by the kernel.

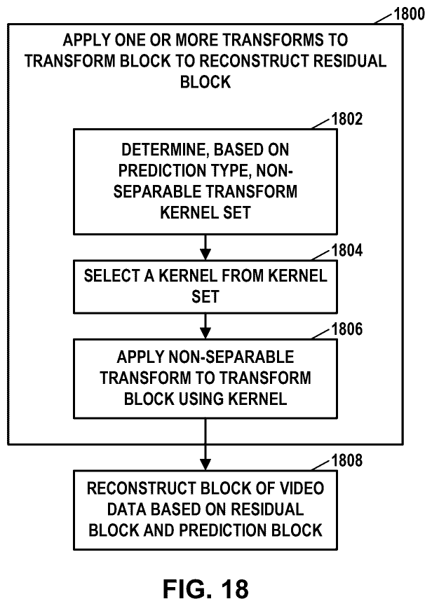

FIG. 18 is a flowchart illustrating an example operation of video decoder 300, in accordance with one or more techniques of this disclosure. In the example of FIG. 18, video decoder 300 (e.g., inverse transform processing unit 308) may apply one or more transforms to a transform block to reconstruct a residual block (1800). As at least part of applying the one or more transforms, video decoder 300 may determine, based on a prediction type associated with the transform block, a non-separable transform kernel set (1802). The non-separable transform kernel set may be a NSPT kernel set or a LFNST kernel set. Video decoder 300 may determine the non-separable transform kernel set in the same way as video encoder 200.

Additionally, video decoder 300 may select a kernel from the non-separable transform kernel set (1804). For example, video decoder 300 may obtain a syntax element from the bitstream that explicitly indicates the kernel to select from the non-separable transform kernel set. Video decoder 300 may apply a non-separable transform to the transform block using the kernel (1806). For instance, inverse transform processing unit 308 of video decoder 300 may multiply an array of transform coefficients of the transform block by an inverse of the kernel. Video decoder 300 may reconstruct a block of the video data based on the residual block and a prediction block (1808). For example, video decoder 300 may add corresponding samples of the residual block and the prediction block to generate reconstructed samples of the block.

The following numbered clauses illustrate one or more aspects of the devices and techniques described in this disclosure.

Clause 1A. A method of coding video data, the method comprising: determining, based on a prediction type associated with a transform block, a kernel for a non-separable transform; and applying a non-separable transform to a transform block using the determined kernel.

Clause 2A. The method of clause 1A, wherein the prediction type is one of: directional intra prediction, template-based intra mode derivation with fusion, decoder-side intra mode derivation (DIMD), spatial geometric partitioning mode (SGPM), extrapolation filter-based intra prediction (EIP), matrix-based intra prediction (MIP), intra template matching prediction (ITMP), intra block copy (IBC), non-affine inter prediction, or affine inter prediction.

Clause 3A. The method of any of clauses 1A-2A, wherein determining the kernel comprises: determining the kernel based on the prediction type associated with the transform block and an intra prediction mode.

Clause 4A. The method of any of clauses 1A-3A, wherein determining the kernel comprises: determining, based on the prediction type and an intra prediction mode, the kernel from a kernel set defined for a subset of combinations of prediction types and intra prediction modes.

Clause 5A. The method of any of clauses 1A-4A, wherein determining the kernel comprises: determining the kernel from a primary kernel set and a secondary kernel set, wherein the primary kernel set is defined for all applicable block shapes, and wherein the secondary kernel set is defined for one or more specific block shapes and prediction types.

Clause 6A. The method of clause 5A, wherein the secondary kernel set is defined only for a non-separable primary transform.

Clause 7A. The method of clause 1A, wherein: the transform block is a first transform block, the non-separable transform is a first non-separable transform; determining the kernel for the first non-separable transform comprises determining, based on the prediction type associated with the first transform block, the kernel for the first non-separable transform from among a set of two or more kernels; the method further comprising: determining, based on a prediction type associated with a second transform block, a kernel for a second non-separable transform from among the set of two or more kernels, the prediction type associated with the second transform block being different from the prediction type associated with the first transform block; and applying the second non-separable transform to the second transform block using the determined kernel for the second non-separable transform.

Clause 8A. The method of clause 1A, wherein: the transform block is a first transform block, the non-separable transform is a first non-separable transform, and the method further comprises applying a second non-separable transform to a second transform block using the kernel, wherein the prediction type associated with the first transform block is different from a prediction type associated with the second transform block.

Clause 9A. The method of clause 8A, further comprising: determining, based on a prediction type associated with a third transform block, an intra mode associated with the third transform block, and block dimensions associated with the third transform block, a kernel for a third non-separable transform, wherein the kernel for the third non-separable transform is different from the kernel for the first non-separable transform, the prediction type associated with the first transform block is different from the prediction type associated with the third transform block and at least one of an intra mode associated with the first transform block is the same as the intra mode associated with the third transform block or block dimensions associated with the first transform block is the same as the block dimensions associated with the third transform block; and applying the third non-separable transform to the third transform block using the determined kernel for the third non-separable transform.

Clause 10A. The method of any of clauses 8A-9A, further comprising: determining, based on a prediction type associated with a third transform block, an intra mode associated with the third transform block, and block dimensions associated with the third transform block, a kernel for a third non-separable transform, wherein the kernel for the third non-separable transform is different from the kernel for the first non-separable transform, the prediction type associated with the first transform block the same as the prediction type associated with the third transform block and at least one of an intra mode associated with the first transform block is different from the intra mode associated with the third transform block or block dimensions associated with the first transform block are different from the block dimensions associated with the third transform block; and applying the third non-separable transform to the third transform block using the determined kernel for the third non-separable transform.

Clause 11A. The method of any of clauses 8A-9A, wherein the prediction type associated with the first transform block and the prediction type associated with the second transform block are in a group of prediction types consisting of: prediction types that apply blending, prediction types having specific statistics, prediction types applying subblock prediction, and inter type prediction.

Clause 12A. A method of coding video data, the method comprising: determining, based on transform block dimensions of a transform block, a kernel for a non-separable transform; and applying the non-separable transform to the transform block using the determined kernel.

Clause 13A. The method of clause 12A, wherein: the transform block is a first transform block, the non-separable transform is a first non-separable transform, and the method further comprises: determining, based on transform block dimensions of a second transform block, a kernel for a second non-separable transform; and applying the second non-separable transform to the second transform block using the kernel for the second non-separable transform, wherein the transform block dimensions of the first transform block are different from the transform block dimensions of the second transform block and the kernel for the first non-separable transform is the same as the kernel for the second non-separable transform.

Clause 14A. The method of clause 13A, further comprising: determining, based on an intra mode associated with a third transform block, a prediction type associated with the third transform block, and block dimensions associated with the third transform block, a kernel for a third non-separable transform, wherein the kernel for the third non-separable transform is different from the kernel for the first non-separable transform, the block dimensions of the third transform block are different from the block dimensions of the first transform block, the intra mode associated with the third transform block is the same as an intra mode associated with the first transform block, and a prediction type set associated with the third transform block is the same as a prediction type set associated with the first transform block; and applying the third non-separable transform to the third transform block using the determined kernel for the third non-separable transform.

Clause 15A. The method of any of clauses 13A-14A, further comprising: determining, based on an intra mode associated with a third transform block, a prediction type associated with the third transform block, and block dimensions associated with the third transform block, a kernel for a third non-separable transform, wherein: the kernel for the third non-separable transform is different from the kernel for the first non-separable transform, the block dimensions of the third transform block are the same as the block dimensions of the first transform block, and one or more of: the intra mode associated with the third transform block is different from an intra mode associated with the first transform block, or a prediction type set associated with the third transform block is different from a prediction type set associated with the first transform block; and applying the third non-separable transform to the third transform block using the determined kernel for the third non-separable transform.

Clause 16A. A method of coding video data, the method comprising: determining a region of interest for a low-frequency non-separable transform (LFNST) region based on one or more of a prediction type associated with a transform block or dimensions of the transform block; and applying a non-separable transform to the region of interest of the transform block.

Clause 17A. A method of coding video data, the method comprising: determining, based on an intra mode associated with a first transform block, a kernel for a first non-separable transform; applying the first non-separable transform to the first transform block using the determined kernel for the first non-separable transform; determining, based on an intra mode associated with a second transform block, a kernel for a second non-separable transform, wherein the intra mode associated with the first transform block is different from the intra mode associated with the second transform block, and the kernel for the first non-separable transform is the same as the kernel for the second non-separable transform; and applying the second non-separable transform to the second transform block using the determined kernel for the second non-separable transform.

Clause 18A. The method of clause 17A, further comprising: determining, based on an intra mode associated with a third transform block, a prediction type associated with the third transform block, and block dimensions of the third transform block, a kernel for a third non-separable transform, wherein the kernel for the third non-separable transform is different from the kernel for the first non-separable transform, and at least one of: the intra mode associated with the third transform block is the same as an intra mode associated with the first transform block, or the block dimensions of the third transform block are the same as block dimensions of the first transform block; and applying the third non-separable transform to the third transform block using the determined kernel for the third non-separable transform.

Clause 19A. The method of any of clauses 17A-18A, further comprising: determining, based on an intra mode associated with a third transform block, a prediction type associated with the third transform block, and block dimensions of the third transform block, a kernel for a third non-separable transform, wherein the kernel for the third non-separable transform is different from the kernel for the first non-separable transform, the intra mode associated with the third transform block is the same as an intra mode associated with the first transform block, and at least one of: the prediction type associated with the third transform block is different from a prediction type associated with the first transform block, or the block dimensions of the third transform block are different from block dimensions of the first transform block; and applying the third non-separable transform to the third transform block using the determined kernel for the third non-separable transform.

Clause 20A. The method of any of clauses 1A-19A, wherein coding comprises decoding.

Clause 21A. The method of any of clauses 1A-19A, wherein coding comprises encoding.

Clause 22A. A device for coding video data, the device comprising one or more means for performing the method of any of clauses 1A-21A.

Clause 23A. The device of clause 22A, wherein the one or more means comprise one or more processors implemented in circuitry.

Clause 24A. The device of any of clauses 22A and 23A, further comprising a memory to store the video data.

Clause 25A. The device of any of clauses 22A-24A, further comprising a display configured to display decoded video data.

Clause 26A. The device of any of clauses 22A-25A, wherein the device comprises one or more of a camera, a computer, a mobile device, a broadcast receiver device, or a set-top box.

Clause 27A. The device of any of clauses 22A-26A, wherein the device comprises a video decoder.

Clause 28A. The device of any of clauses 22A-27A, wherein the device comprises a video encoder.

Clause 29A. A computer-readable storage medium having stored thereon instructions that, when executed, cause one or more processors to perform the method of any of clauses 1A-21A.

Clause 1B. A device for decoding video data, the device comprising: a memory configured to store the video data; and one or more processors implemented in circuitry, the one or more processors configured to: apply one or more transforms to a transform block to reconstruct a residual block, wherein the one or more processors are configured to, as at least part of applying the one or more transforms: determine, based on a prediction type associated with the transform block, a non-separable transform kernel set, wherein the non-separable transform kernel set is a non-separable primary transform (NSPT) kernel set or a low-frequency non-separable transform (LFNST) kernel set; select a kernel from the non-separable transform kernel set; and apply a non-separable transform to the transform block using the kernel; and reconstruct a block of the video data based on the residual block and a prediction block.

Clause 2B. The device of clause 1B, wherein the prediction type associated with the transform block is one of: directional intra prediction, template-based intra mode derivation with fusion, decoder-side intra mode derivation (DIMD), spatial geometric partitioning mode (SGPM), extrapolation filter-based intra prediction (EIP), matrix-based intra prediction (MIP), intra template matching prediction (ITMP), intra block copy (IBC), non-affine inter prediction, or affine inter prediction.

Clause 3B. The device of any of clauses 1B-2B, wherein: for a single fixed set of transform block dimensions, the memory is configured to store a plurality of separate non-separable kernel sets for a plurality of different combinations of prediction types and intra prediction modes; and the one or more processors are configured to, as at least part of determining the non-separable transform kernel set, determine the non-separable transform kernel set based on the prediction type associated with the transform block and an intra prediction mode associated with the transform block.

Clause 4B. The device of any of clauses 1B-3B, wherein the one or more processors are configured to, as part of determining the non-separable transform kernel set, determine the non-separable transform kernel set based on the transform block having specific fixed transform block dimensions and having a specific combination of a prediction type and an intra prediction mode.

Clause 5B. The device of any of clauses 1B-4B, wherein the one or more processors are configured to, as at least part of determining the non-separable transform kernel set, determine the non-separable transform kernel set from a primary kernel set and a secondary kernel set, wherein the primary kernel set is defined for all block shapes in a predefined set of block shapes, and wherein the secondary kernel set is defined for one or more specific block shapes and prediction types.

Clause 6B. The device of clause 5B, wherein the secondary kernel set is defined only for a non-separable primary transform.

Clause 7B. The device of any of clauses 1B-6B, wherein: the one or more processors are configured to, as at least part of determining the non-separable transform kernel set, determine the non-separable transform kernel set based on a prediction type of the transform block, and the kernel is selectable for transform units that (i) are associated with a set of prediction types that includes two or more different prediction types and (ii) are associated with a same specific intra mode and same specific block dimensions.

Clause 8B. The device of clause 7B, wherein: the transform block is a first transform block, the kernel is a first kernel, and the non-separable transform is a first non-separable transform, to select the first kernel, the one or more processors are configured to select, based on an intra mode associated with the first transform block, the first kernel from the non-separable transform kernel set, and the one or more processors are further configured to: select, based on an intra mode associated with a second transform block, the first kernel from the non-separable transform kernel set, wherein the first transform block and the second transform block are associated with different prediction types, both have same block dimensions, and the intra mode associated with the first transform block is the same as the intra mode associated with the second transform block; apply the first non-separable transform to the second transform block using the first kernel; and select, based on an intra mode associated with a third transform block, a second kernel from the non-separable transform kernel set, wherein a prediction type associated with the third transform block is the same as the prediction type associated with the first transform block, and at least one of: (i) the intra mode associated with the third transform block is different from the intra mode associated with the first transform block or (ii) block dimensions of the third transform block are different from the block dimensions of the first transform block.

Clause 9B. The device of any of clauses 7B-8B, wherein: the set of prediction types is a first set of prediction types, the kernel is not selectable for a second set of prediction types, the first set of prediction types includes two or more of: prediction types that apply blending, EIP, MIP, prediction types that apply subblock prediction, and inter prediction types, and the second set of prediction types includes directional intra prediction.

Clause 10B. The device of any of clauses 1B-9B, wherein: the transform block is a first transform block, the residual block is a first residual block, and the block is a first block, the first transform block and a second transform block are associated with a same set of a prediction type and block dimensions, the kernel is a first kernel, to select the first kernel, the one or more processors are configured to select, based on an intra mode associated with the first transform block, the first kernel from the non-separable transform kernel set, wherein the first kernel is applicable to at least two intra modes; the one or more processors are further configured to: apply one or more transforms to the transform block to reconstruct a second residual block, wherein the one or more processors are configured to, as part of applying the one or more transforms: select, based on an intra mode associated with a second transform block, a second kernel from the non-separable transform kernel set, wherein the intra mode associated with the second transform block is not one of the at least two intra modes; and apply a non-separable transform to the second transform block using the second kernel; and reconstruct a second block of the video data based on the second residual block and a prediction block.

Clause 11B. The device of any of clauses 1B-10B, wherein: the transform block is a first transform block, the kernel is a first kernel, and the non-separable transform is a first non-separable transform, to determine the first kernel, the one or more processors are configured to determine, based on an intra mode associated with the first transform block, the first kernel from the non-separable transform kernel set, and the one or more processors are further configured to: select, based on an intra mode associated with a second transform block, the first kernel from the non-separable transform kernel set, wherein the first transform block and the second transform block are both associated with a first prediction type, both have same block dimensions, and the intra mode associated with the first transform block is different from the intra mode associated with the second transform block; apply the first non-separable transform to the second transform block using the first kernel; select, based on an intra mode associated with a third transform block, a second kernel from the non-separable transform kernel set, wherein the intra mode associated with the third transform block is the same as the intra mode associated with the first transform block or the intra mode associated with the second transform block, and the third transform block is associated with a second prediction type different from the first prediction type or block dimensions of the third transform block are different from the block dimensions of the first transform block and the block dimensions of the second transform block; and apply a second non-separable transform to the third transform block using the second kernel.

Clause 12B. The device of any of clauses 1B-11B, further comprising a display configured to display decoded video data, wherein the device comprises one or more of a camera, a computer, a mobile device, a broadcast receiver device, or a set-top box.

Clause 13B. A method of decoding video data, the method comprising: determining, based on a prediction type associated with a transform block, a non-separable transform kernel set, wherein the non-separable transform kernel set is a non-separable primary transform (NSPT) kernel set or a low-frequency non-separable transform (LFNST) kernel set; selecting a kernel from the non-separable transform kernel set; applying one or more transforms to the transform block to reconstruct a residual block, wherein applying the one or more transforms comprises applying a non-separable transform to the transform block using the kernel; and reconstructing a block of the video data based on the residual block and a prediction block.

Clause 14B. The method of clause 13, wherein the prediction type associated with the transform block is one of: directional intra prediction, template-based intra mode derivation with fusion, decoder-side intra mode derivation (DIMD), spatial geometric partitioning mode (SGPM), extrapolation filter-based intra prediction (EIP), matrix-based intra prediction (MIP), intra template matching prediction (ITMP), intra block copy (IBC), non-affine inter prediction, or affine inter prediction.

Clause 15B. The method of any of clauses 13B-14B, wherein: for a single fixed set of transform block dimensions, storing, in a memory, a plurality of separate non-separable kernel sets for a plurality of different combinations of prediction types and intra prediction modes; and determining the non-separable transform kernel set comprises determining the non-separable transform kernel set based on the prediction type associated with the transform block and an intra prediction mode associated with the transform block.

Clause 16B. The method of any of clauses 13B-15B, wherein determining the non-separable transform kernel set comprises determining the non-separable transform kernel set based on the transform block having specific fixed transform block dimensions and having a specific combination of a prediction type and an intra prediction mode.

Clause 17B. The method of any of clauses 13B-16B, wherein determining the non-separable transform kernel set comprises: determining the non-separable transform kernel set from a primary kernel set and a secondary kernel set, wherein the primary kernel set is defined for all block shapes in a predefined set of block shapes, and wherein the secondary kernel set is defined for one or more specific block shapes and prediction types.

Clause 18B. The method of any of clauses 13B-17B, wherein: determining the non-separable transform kernel set comprises determining the non-separable transform kernel set based on a prediction type of the transform block, the kernel is selectable for transform units that (i) are associated with a set of prediction types that includes two or more different prediction types and (ii) are associated with a same specific intra mode and same specific block dimensions.

Clause 19B. The method of any of clauses 13B-18B, wherein: the transform block is a first transform block, the first transform block and a second transform block have a same set of a prediction type and block dimensions, the kernel is a first kernel, selecting the first kernel comprises selecting, based on an intra mode associated with the first transform block, the first kernel from the non-separable transform kernel set, wherein the first kernel is applicable to at least two intra modes; the method further comprises: selecting, based on an intra mode associated with a second transform block, a second kernel from the non-separable transform kernel set, wherein the intra mode associated with the second transform block is not one of the at least two intra modes.

Clause 20. One or more non-transitory computer-readable storage media having instructions stored thereon that, when executed by one or more processors, cause the one or more processors to: determine, based on a prediction type associated with a transform block, a non-separable transform kernel set, wherein the non-separable transform kernel set is a non-separable primary transform (NSPT) kernel set or a low-frequency non-separable transform (LFNST) kernel set; select a kernel from the non-separable transform kernel set; apply one or more transforms to the transform block to reconstruct a residual block, wherein applying the one or more transforms comprises applying a non-separable transform to the transform block using the kernel; and reconstruct a block of video data based on the residual block and a prediction block.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for decoding video data, the device comprising:
a memory configured to store the video data; and
one or more processors implemented in circuitry, the one or more processors configured to:
apply one or more transforms to a transform block to reconstruct a residual block, wherein the one or more processors are configured to, as at least part of applying the one or more transforms:
determine, based on a prediction type associated with the transform block, a non-separable transform kernel set, wherein the non-separable transform kernel set is a non-separable primary transform (NSPT) kernel set or a low-frequency non-separable transform (LFNST) kernel set;
select a kernel from the non-separable transform kernel set; and
apply a non-separable transform to the transform block using the kernel; and
reconstruct a block of the video data based on the residual block and a prediction block.

2. The device of claim 1, wherein the prediction type associated with the transform block is one of: directional intra prediction, template-based intra mode derivation with fusion, decoder-side intra mode derivation (DIMD), spatial geometric partitioning mode (SGPM), extrapolation filter-based intra prediction (EIP), matrix-based intra prediction (MIP), intra template matching prediction (ITMP), intra block copy (IBC), non-affine inter prediction, or affine inter prediction.

3. The device of claim 1, wherein:
for a single fixed set of transform block dimensions, the memory is configured to store a plurality of separate non-separable kernel sets for a plurality of different combinations of prediction types and intra prediction modes; and
the one or more processors are configured to, as at least part of determining the non-separable transform kernel set, determine the non-separable transform kernel set based on the prediction type associated with the transform block and an intra prediction mode associated with the transform block.

4. The device of claim 1, wherein the one or more processors are configured to, as part of determining the non-separable transform kernel set, determine the non-separable transform kernel set based on the transform block having specific fixed transform block dimensions and having a specific combination of a prediction type and an intra prediction mode.

5. The device of claim 1, wherein the one or more processors are configured to, as at least part of determining the non-separable transform kernel set, determine the non-separable transform kernel set from a primary kernel set and a secondary kernel set, wherein the primary kernel set is defined for all block shapes in a predefined set of block shapes, and wherein the secondary kernel set is defined for one or more specific block shapes and prediction types.

6. The device of claim 5, wherein the secondary kernel set is defined only for a non-separable primary transform.

7. The device of claim 1, wherein:
the one or more processors are configured to, as at least part of determining the non-separable transform kernel set, determine the non-separable transform kernel set based on a prediction type of the transform block, and
the kernel is selectable for transform units that (i) are associated with a set of prediction types that includes two or more different prediction types and (ii) are associated with a same specific intra mode and same specific block dimensions.

8. The device of claim 7, wherein:
the transform block is a first transform block, the kernel is a first kernel, and the non-separable transform is a first non-separable transform,
to select the first kernel, the one or more processors are configured to select, based on an intra mode associated with the first transform block, the first kernel from the non-separable transform kernel set, and
the one or more processors are further configured to:
select, based on an intra mode associated with a second transform block, the first kernel from the non-separable transform kernel set, wherein the first transform block and the second transform block are associated with different prediction types, both have same block dimensions, and the intra mode associated with the first transform block is the same as the intra mode associated with the second transform block;
apply the first non-separable transform to the second transform block using the first kernel; and
select, based on an intra mode associated with a third transform block, a second kernel from the non-separable transform kernel set, wherein a prediction type associated with the third transform block is the same as the prediction type associated with the first transform block, and at least one of: (i) the intra mode associated with the third transform block is different from the intra mode associated with the first transform block or (ii) block dimensions of the third transform block are different from the block dimensions of the first transform block.

9. The device of claim 7, wherein:
the set of prediction types is a first set of prediction types, the kernel is not selectable for a second set of prediction types,
the first set of prediction types includes two or more of: prediction types that apply blending, EIP, MIP, prediction types that apply subblock prediction, and inter prediction types, and
the second set of prediction types includes directional intra prediction.

10. The device of claim 1, wherein:
the transform block is a first transform block, the residual block is a first residual block, and the block is a first block,
the first transform block and a second transform block are associated with a same set of a prediction type and block dimensions,
the kernel is a first kernel,
to select the first kernel, the one or more processors are configured to select, based on an intra mode associated with the first transform block, the first kernel from the non-separable transform kernel set, wherein the first kernel is applicable to at least two intra modes;
the one or more processors are further configured to:
apply one or more transforms to the transform block to reconstruct a second residual block, wherein the one or more processors are configured to, as part of applying the one or more transforms:
select, based on an intra mode associated with a second transform block, a second kernel from the non-separable transform kernel set,
wherein the intra mode associated with the second transform block is not one of the at least two intra modes; and
apply a non-separable transform to the second transform block using the second kernel; and
reconstruct a second block of the video data based on the second residual block and a prediction block.

11. The device of claim 1, wherein:
the transform block is a first transform block, the kernel is a first kernel, and the non-separable transform is a first non-separable transform,
to determine the first kernel, the one or more processors are configured to determine, based on an intra mode associated with the first transform block, the first kernel from the non-separable transform kernel set, and
the one or more processors are further configured to:
select, based on an intra mode associated with a second transform block, the first kernel from the non-separable transform kernel set, wherein the first transform block and the second transform block are both associated with a first prediction type, both have same block dimensions, and the intra mode associated with the first transform block is different from the intra mode associated with the second transform block;
apply the first non-separable transform to the second transform block using the first kernel;
select, based on an intra mode associated with a third transform block, a second kernel from the non-separable transform kernel set, wherein the intra mode associated with the third transform block is the same as the intra mode associated with the first transform block or the intra mode associated with the second transform block, and the third transform block is associated with a second prediction type different from the first prediction type or block dimensions of the third transform block are different from the block dimensions of the first transform block and the block dimensions of the second transform block; and
apply a second non-separable transform to the third transform block using the second kernel.

12. The device of claim 1, further comprising a display configured to display decoded video data, wherein the device comprises one or more of a camera, a computer, a mobile device, a broadcast receiver device, or a set-top box.

13. A method of decoding video data, the method comprising:
determining, based on a prediction type associated with a transform block, a non-separable transform kernel set, wherein the non-separable transform kernel set is a non-separable primary transform (NSPT) kernel set or a low-frequency non-separable transform (LFNST) kernel set;
selecting a kernel from the non-separable transform kernel set;
applying one or more transforms to the transform block to reconstruct a residual block, wherein applying the one or more transforms comprises applying a non-separable transform to the transform block using the kernel; and
reconstructing a block of the video data based on the residual block and a prediction block.

14. The method of claim 13, wherein the prediction type associated with the transform block is one of: directional intra prediction, template-based intra mode derivation with fusion, decoder-side intra mode derivation (DIMD), spatial geometric partitioning mode (SGPM), extrapolation filter-based intra prediction (EIP), matrix-based intra prediction (MIP), intra template matching prediction (ITMP), intra block copy (IBC), non-affine inter prediction, or affine inter prediction.

15. The method of claim 13, wherein:
for a single fixed set of transform block dimensions, storing, in a memory, a plurality of separate non-separable kernel sets for a plurality of different combinations of prediction types and intra prediction modes; and
determining the non-separable transform kernel set comprises determining the non-separable transform kernel set based on the prediction type associated with the transform block and an intra prediction mode associated with the transform block.

16. The method of claim 13, wherein determining the non-separable transform kernel set comprises determining the non-separable transform kernel set based on the transform block having specific fixed transform block dimensions and having a specific combination of a prediction type and an intra prediction mode.

17. The method of claim 13, wherein determining the non-separable transform kernel set comprises:
determining the non-separable transform kernel set from a primary kernel set and a secondary kernel set, wherein the primary kernel set is defined for all block shapes in a predefined set of block shapes, and wherein the secondary kernel set is defined for one or more specific block shapes and prediction types.

18. The method of claim 13, wherein:
determining the non-separable transform kernel set comprises determining the non-separable transform kernel set based on a prediction type of the transform block,
the kernel is selectable for transform units that (i) are associated with a set of prediction types that includes two or more different prediction types and (ii) are associated with a same specific intra mode and same specific block dimensions.

19. The method of claim 13, wherein:
the transform block is a first transform block,
the first transform block and a second transform block have a same set of a prediction type and block dimensions,
the kernel is a first kernel,
selecting the first kernel comprises selecting, based on an intra mode associated with the first transform block, the first kernel from the non-separable transform kernel set, wherein the first kernel is applicable to at least two intra modes;
the method further comprises:
selecting, based on an intra mode associated with a second transform block, a second kernel from the non-separable transform kernel set, wherein the intra mode associated with the second transform block is not one of the at least two intra modes.

20. One or more non-transitory computer-readable storage media having instructions stored thereon that, when executed by one or more processors, cause the one or more processors to:
determine, based on a prediction type associated with a transform block, a non-separable transform kernel set, wherein the non-separable transform kernel set is a non-separable primary transform (NSPT) kernel set or a low-frequency non-separable transform (LFNST) kernel set;
select a kernel from the non-separable transform kernel set;
apply one or more transforms to the transform block to reconstruct a residual block, wherein applying the one or more transforms comprises applying a non-separable transform to the transform block using the kernel; and
reconstruct a block of video data based on the residual block and a prediction block.
